(19) United States
(12) Patent Application Publication
(10) Pub. No.: US 2016/0218352 A1
(43) Pub. Date: Jul. 28, 2016

(54) LITHIUM-SULFUR ELECTRIC CURRENT PRODUCING CELL

(71) Applicant: COMMONWEALTH SCIENTIFIC AND INDUSTRIAL RESEARCH ORGANISATION, Campbell, ACT (AU)

(72) Inventors: Mustafa Musameh, Wantirna South, Victoria (AU); Adam Best, Ferntree Gully, Victoria (AU); Thomas Ruether, Ormond, Victoria (AU)

(73) Assignee: COMMONWEALTH SCIENTIFIC AND INDUSTRIAL RESEARCH ORGANISATION, Campbell, ACT (AU)

(21) Appl. No.: 14/914,295

(22) PCT Filed: Aug. 29, 2014
(86) PCT No.: PCT/AU2014/000862

§ 371 Date: Feb. 25, 2016

(30) Foreign Application Priority Data
Aug. 29, 2013 (AU) 2013903291

(51) Int. Cl. H01M 4/36; H01M 4/136; H01M 4/38; H01M 4/62; H01M 10/0569; H01M 10/052; H01M 4/60

(52) U.S. Cl. CPC H01M 4/364; H01M 10/052; H01M 4/136; H01M 4/604; H01M 4/624; H01M 10/0569; H01M 4/38; H01M 2004/028

(57) ABSTRACT

The invention provides a lithium-sulfur electric current producing cell comprising an anode; electrolyte; and cathode, where the cathode comprises a polymer-sulfur composite comprising: 5 to 80 wt % sulfur; 0 to 90 wt % conductive polymer; 0 to 50 wt % of one or more conductive agents, other than the conductive polymer; and 0.5 to 20 wt % a first dopant comprising a negatively charged organic polymer; wherein the conductive polymer is doped with the first dopant.

### FIELD OF THE INVENTION

The present invention relates to lithium-sulfur electric current producing cells. More particularly, the current invention relates to polymer-sulfur composite materials for use in a cathode for the cell and to ionic liquid electrolyte solutions for the cell.

### BACKGROUND TO THE INVENTION

Secondary/rechargeable batteries, because of their high energy density and high capacity, can be used as energy storage devices for mobile information devices. They are also used in tools, electrically operated automobiles, and in hybrid drive automobiles. Requirements as regards electrical capacity and energy density for such batteries are high. In particular, they have to remain stable during charging and discharging cycles, i.e., have as little loss of electrical capacity as possible.

While it is already possible to obtain high charge/discharge cycle capacities with lithium ion batteries, this has not been achieved so far with lithium-sulfur batteries. A long service life would, however, be desirable for lithium-sulfur batteries, since they have a substantially higher (theoretical) specific energy density than conventional lithium ion batteries.

The basis of a lithium-sulfur battery is the electrochemical reaction between lithium and sulfur, for example: 16Li+S₈⇄Li₂S. Unfortunately, polysulfides, Li₂Sₓ (1≦x≦8) formed at the sulfur electrode during discharge can dissolve in the electrolyte of the battery and remain dissolved therein. The high solubility of polysulfide results in loss of active electrode mass. Simultaneously, polysulfide anions can migrate to the lithium metal electrode, where they can form insoluble products which have a negative effect on the performance of the battery. The good solubility of the polysulfides in electrolyte is a particular problem with lithium sulfur batteries as polysulfides which diffuses from the cathodic region into the anodic region, are reduced to insoluble precipitates (Li₂S₂ and/or Li₂S), leading to the loss of active material at the cathode and a decrease in the capacity of the lithium sulfur battery. In total, these effects results in an unsatisfactorily short service life for a lithium-sulfur battery in the charge and discharge cycle, restricting the use of lithium-sulfur batteries.

US 2009/0226809 A1 describes lithium sulfur batteries and cathodes wherein the cathode comprises a composition containing 20 to 90 wt % of sulfur and 0.01 to 50 wt % of a metal oxide such as CuO, SnO and ZnO, which may further contain a binder and an electrically conductive carbon material such as carbon black, synthetic graphite including expanded graphite, graphite nanosheets, graphite nanoplatelets, graphene sheets, non-synthetic graphite (including natural graphite and coke) and graphitized carbon nano-fibres. It is believed that the metal oxide contributes in holding polysulfides within the cathode thereby lessening polysulfide diffusion. These compositions have the drawback that the discharge voltage is reduced to varying degrees depending on the metal oxide used. Furthermore, the gravimetric energy density of the cathode material is lower due to the higher density of the transitional metal oxides present in comparison with sulfur.

A second major problem is that sulfur itself is an electrically insulating material and therefore an electrically conductive agent is necessary to connect the sulfur with the current collector and current supply, respectively. Furthermore, the sulfur has to be in contact with the electrolyte to be electrochemically active.

Several materials have been suggested as suitable conductive agents in the prior art. For example, US 2004/0058246 A1 describes a positive active material for a lithium sulfur battery wherein the conductive agent is selected from carbon black, graphite, carbon fibre, carbon nanotubes, activated carbon, a metal powder or metal compound, and mixtures thereof.

Despite the fact that there has been long and intense research in the field of lithium sulfur batteries, there is still the need for further improvement to obtain lithium sulfur batteries which are capable of being charged/discharged a high number of cycles without losing too much of their capacity. This is a prerequisite for a widespread commercial use of lithium sulfur batteries.

Any discussion of the prior art throughout the specification should in no way be considered as an admission that such prior art is widely known or forms part of common general knowledge in the field.

It is an object of the present invention to overcome or ameliorate at least one of the disadvantages of the prior art, or to provide a useful alternative.

### SUMMARY OF THE INVENTION

According to one aspect of the present invention there is provided a lithium-sulfur electric current producing cell comprising:
a) Anode;
b) Electrolyte; and
c) Cathode comprising a polymer-sulfur composite comprising:
   5 to 80 wt % sulfur;
   10 to 90 wt % conductive polymer; and
   0 to 50 wt % of one or more conductive agents, other than the conductive polymer; and
   0.5 to 20 wt % of a first dopant comprising a negatively charged organic polymer,
      wherein the conductive polymer is doped with the negatively charged organic polymer.

Preferably, the lithium-sulfur electric current producing cell of the invention comprises:
a) Anode;
b) Electrolyte; and
c) Cathode comprising a polymer-sulfur composite comprising:
   5 to 75 wt % sulfur;
   10 to 70 wt % conductive polymer; and
   0 to 50 wt % of one or more conductive agents, other than the conductive polymer; and
   1 to 20 wt % of a first dopant comprising a negatively charged organic polymer,
      wherein the conductive polymer is doped with the negatively charged organic polymer.

It should be appreciated that the lithium-sulfur electric current producing cell of the invention forms the basis for a lithium-sulfur battery, that is, a rechargeable battery which comprises an anode comprising lithium metal (a lithium metal anode), together with a S-containing cathode and other cell components as described herein, wherein, in addition to anodic lithium metal, lithium ions and/or lithium compounds are also present in the electrolyte or are present at electrode surfaces, for example, Li₂S₈, Li₂Sₙ, n=1 to 8 (polysulfides), Li₂S₂, Li₂S etc.

It should be also appreciated that as used herein, the term “organic” used in the feature “negatively charged organic polymer” means organic (carbon based) polymers, but also includes organic polymers that have hybrid components of an inorganic nature, for example, inorganic backbones substituted with organic groups, or organic backbones substituted with inorganic groups. In one embodiment the negatively charged organic polymer is free of inorganic or hybrid components.

The lithium sulfur electric cell of the present invention has been found to have excellent charging and discharging characteristics. Without being bound by any theory, it is thought that the doping of a negatively charged organic polymer in the conductive polymer results in a more open structure which allows for greater mobility of lithium ions, thus improving overall cell performance.

Preferred cells of the invention exhibit a discharge capacity of at least 100 mAh/g (based on amount of S in cathode) more preferably at least 200 mAh/g, even more preferably at least 300 mAh/g, yet even more preferably at least 400 mAh/g, yet even more preferably still at least 500 mAh/g and most preferably at least 1000 mAh/g on at least the 10^{th} cycle.

Preferred cells of the invention exhibit a discharge capacity of at least 200 mAh/g (based on amount of S in cathode), more preferably at least 300 mAh/g, even more preferably at least 400 mAh/g, yet even more preferably at least 500 mAh/g, and yet even more preferably at least 1000 mAh/g on at least the 2^{nd}, 3^{rd}, 4^{th}, 5^{th}, 6^{th}, 7^{th}, 8^{th} and/or the 9^{th} cycles. These particular performance criteria are particularly desired for the 9^{th} cycle.

Preferred cells of the invention exhibit a charge capacity of at least 100 mAh/g, more preferably at least 200 mAh/g, even more preferably at least 300 mAh/g, yet even more preferably at least 400 mAh/g yet even more preferably still at least 500 mAh/g, and most preferably at least 1000 mAh/g on at least the 10^{th} cycle.

Preferred cells of the invention exhibit a discharge capacity of at least 200 mAh/g, more preferably at least 300 mAh/g, even more preferably at least 400 mAh/g, yet even more preferably at least 500 mAh/g and yet even more preferably at least 1000 mAh/g on at least the 2^{nd}, 3^{rd}, 4^{th}, 5^{th}, 6^{th}, 7^{th}, 8^{th} or 9^{th} cycles. These particular performance criteria are particularly desired for the 9^{th} cycle.

Preferred cells of the invention exhibit a % change in the absolute values of the charge capacity and/or discharge capacity over at least the cycle 2 to cycle 10 of less than 40%, more preferably less than 35%, more preferably less than 30%, more preferably less than 25%, more preferably less than 15%, more preferably less than 10%, and more preferably still less than 5%.

Suitably, these desirable capacities and/or desirable % change of capacity may be observed at a charge/discharge rate of between C/1 to C/200, more preferably between C/3 and C/150, yet even more preferably between C/5 and C/100, or yet even more preferably still at between C/10 and C/75. A particularly preferred rate in this context is C/3, C/10 or C/100. In some embodiments, these desirable characteristic can be observed more than C rate.

The weight ratio of the conductive polymer to the negatively charged organic polymer is preferably between about 20:1 and about 1:1, more preferably between about 10:1 to about 2:1 and most preferably between about 6:1 to about 3:1.

Preferably, the polymer-sulfur composite further comprises an optional second dopant. Without being bound by any theory, the second dopant is thought to improve the wettability of the surface of the polymer sulfur composite with the electrolyte, and thus improves transfer of lithium and polysulfides, while increasing sulfur loading, and reducing cathode resistance.

The composite material of the invention is such that the electrode wettability, as measured by the apparent contact angle of the cathode surface with the electrolyte, is preferably less than 20° degrees at time=10 seconds (after wetting), and more preferably is less than 10° degrees after 10 seconds (after wetting).

The second dopant, when present, for example, in a second layer of conducting polymer, preferably comprises between about 5 wt % and about 40 wt %, more preferably between about 10 wt % and about 35 wt %, and even more preferably between about 20 wt % and about 30 wt % of the total polymer-sulfur composite.

In another aspect of the present invention, there is provided a polymer-sulfur composite comprising:
5 to 80 wt % sulfur;
10 to 90 wt % conductive polymer;
0 to 50 wt % of one or more conductive agents, other than the conductive polymer; and
0.5 to 20 wt % of a first dopant comprising a negatively charged organic polymer,
wherein the conductive polymer is doped with the negatively charged organic polymer.

In a preferred embodiment, there is provided a polymer-sulfur composite comprising:
5 to 75 wt % sulfur;
10 to 70 wt % conductive polymer;
0 to 50 wt % of one or more conductive agents, other than the conductive polymer; and
1 to 20 wt % of a first dopant comprising a negatively charged organic polymer,
wherein the conductive polymer is doped with the negatively charged organic polymer.

In a further aspect of the present invention, there is provided a use of a polymer-sulfur composite as described herein in a cathode of a lithium-sulfur electric current producing cell, particularly, a cell as described herein. Thus, the polymer-sulfur composite as described herein is suitable for use in a cathode of a lithium-sulfur electric current producing cell, particularly, a cell as described herein. It will be appreciated that the cathode material discussed herein is preferably a material porous to sulphur and to the electrolyte.

In a further aspect of the present invention, there is provided a use of an electrolyte as described herein in a lithium-sulfur electric current producing cell, particularly, a cell as described herein. Therefore, the electrolyte as described herein is suitable for use in a lithium-sulfur electric current producing cell, particularly, a cell as described herein.

In a further aspect of the present invention, there is provided a cathode comprising a polymer-sulfur composite as described herein.

In a further aspect of the present invention, there is provided a process for preparing a polymer-sulfur composite cathode comprising the step of coating the polymer-sulfur composite as described herein onto a cathode support.

In a further aspect, the invention provides a use of a negatively charged organic polymer, as described herein, in a cathode composite material of a lithium-sulfur electric current producing cell to increase the cell performance compared to a cell without a cathode comprising the negatively charged organic polymer.

In a further aspect, the invention provides a method of improving the performance of lithium-sulfur electric current producing cell comprising the step of doping one or more of a first and/or second layer of a cathode composite material used in the cell with at least one of a first and second dopant as defined herein.

In a further aspect, the invention provides a method of improving the performance of lithium-sulfur electric current producing cell comprising utilising an electrolyte as defined herein in the cell.

In a further aspect, the invention provides a method of improving the performance of lithium-sulfur electric current producing cell comprising using a doped cathode composite material as described herein in the cell in conjugation with an electrolyte as described herein.

Performance is indicated by improvements in at least one of discharge capacity, charging capacity, sulfur content and/or loading, cathode wettability and cycling stability of a comparable cell comprising a cathode that is not doped in accordance with the present invention.

### Lithium-Sulfur Electric Current Producing Cell

The lithium sulfur electric current producing cell of the present invention preferably includes all energy storage devices, including primary batteries, secondary batteries, hybrid capacitors, capacitors, and the like. The anion is preferably a Li metal anode.

### Electrically Conductive Cathode Supports

Suitable cathode supports include carbon fibre cloth, carbon ink coated aluminium foil, gold sputtered aluminium foil and stainless steel mesh. Preferably, the cathode supports are flexible.

### Separator

The cells of the present invention may further comprise a separator interposed between the cathode and anode. Typically, the separator is a porous non-conductive or insulative material that separates or insulates the anode and the cathode from each other, and which permits the transport of ions through the separator between the anode and the cathode.

A variety of separator materials are known in the art. Examples of suitable solid porous separator materials include, but are not limited to, polyolefins, such as, for example, polyethylenes, polypropylenes, glass fiber filter papers, and ceramic materials. Further examples of separators and separator materials suitable for use in this invention are those comprising a microporous pseudo-boehmite layer, which may be provided either as a free standing film or by a direct coating application on one of the electrodes, as described in U.S. Pat. No. 6,153,337, by Carlson et al, the relevant parts of which are incorporated herein by reference. Separators of a wide range of thickness may be used, for example from about 5 microns to about 50 microns, more preferably from about 5 microns to about 25 microns.

### Polymer Sulfur Composite

The polymer-sulfur composite of the invention, as described herein can constitute a single layer, however, in preferred embodiment, it preferably comprises at least two layers, preferably having a first layer proximal to a cathode support and a second layer distal to the cathode support. The first and second layers may comprise different components and amounts of the components as described herein, depending on the desired cell performance criteria for a particular application.

Preferably, the first layer is less than 10 microns thick and/or the second layer is less than 100 microns thick. In one embodiment, the first layer preferably does not comprise second dopant. However, it should be appreciated that after cycling of the energy storage device, there may be some migration of the second dopant to the first layer.

### Sulfur

The composite material of the invention preferably comprises sulfur in an amount of from about 5 to about 80 wt % sulfur, more preferably, from about 10 wt % to about 80 wt % sulfur, and more preferably still from about 15 wt % to about 75 wt % sulfur. In one embodiment, the sulfur is present in an amount of from about 5 wt % to about 75 wt %, about 10 wt % to about 50 wt %, more preferably from about 15 wt % to about 40 wt %. In some embodiments, lower sulfur content may result in lower capacity and poor cell performance and cycle life, while higher sulfur content may lead to higher resistance and lower utilization of full capacity. Generally, it has been found that the higher end of the ranges disclosed herein are important for high energy battery performance.

Elemental sulfur is typically used, and is preferably in the form of particulate, powder or flakes. The sulfur is preferably micro sulfur (e.g. particles having an average diameter of from about 10 to about 300 microns) (FIG. 3) or nano sulfur (e.g. less than about 100 nm an average diameter and more preferably has an average diameter of about 50 nm) (FIG. 2). However, in a preferred embodiment, the sulfur may be provided in the form of carbon nanotubes infused with sulfur.

In one embodiment, during formation of the first layer of composite, sulfur is initially dispersed into a solvent containing the first dopant and carbon black and is deposited onto the substrate/current collector. Then, in a second step where a second layer is desired, the second dopant, when present, is added to the original mixture and is then electrodeposited onto the first layer to form a two layer composite.

In a preferred embodiment, sulfur is initially absorbed onto a source of carbon, preferably one or more of carbon nanotubes (functionalised or unfunctionalised), meso-porous carbon, graphene oxide (functionalised or unfunctionalised) and any other forms of carbon used by those skilled in the art. This approach may be utilised instead of dispersing sulfur powder or flakes into the solution, and in some embodiments has the advantages of (i) minimising leaching of sulfur/polysulphides into electrolyte; (ii) easier dispersion carbon/sulfur into the mixture; and (iii) improved electrical conductivity.

### Conductive Polymers

The composite material of the invention preferably comprises one or more conductive polymers in an amount of between about 10 wt % and about 90 wt %, preferably between about 10 wt % to about 70 wt %, more preferably about 20 wt % to about 65 wt %, and more preferably still between about 30 wt % to about 60 wt %. In one embodiment, the conductive polymers may be present in an amount of from between about 25 wt % and about 85 wt % of the total composite material. For purposes of clarity, it should be appreciated that these masses also include the dopant counter-ions used to balance charge on the polymer in the oxidised state. In certain cell system, a lower conductive polymer content may result in higher resistance and lower cell performance, while a higher conductive polymer content may lead to lower wettability due to lower porosity.

The conductive polymers of the invention are preferably selected from the group consisting of polythiophene, polypyrrole, polyphenylene, polyaniline, polyacetylene, polyaromatic amines, and derivatives thereof, and combinations thereof. Polypyrrole conducting polymers are particularly preferred.

### Conductive Agents

The composite material of the invention preferably comprises one or more conductive agents in an amount of up to about 50 wt %, more preferably from 0 to about 50 wt %, where in one preferred embodiment, the conductive agents are entirely optional, i.e., is present in an amount of 0 wt %. In another embodiment the composite material of the invention preferably comprises conductive agents in an amount of between about 5 wt % and about 40 wt % and more preferably between about 10 wt % and about 30 wt %.

The one or more conductive agents are preferably selected from the group consisting of carbon, carbon black, graphite, expanded graphite, graphene, carbon fibres, carbon nanotubes, activated carbon, mesoporous carbon, carbon prepared by heat-treating cork or pitch, metal flakes, metal powder, metal compounds, and mixtures thereof. Preferably, the conductive agent comprises carbon tubes or nanotubes, more preferably, carbon nanotubes infused with sulfur.

Without being bound by any theory, it is believed that the one or more conductive agents, such as the carbon tubes or nanotubes described herein, assist in mitigating polysulfides leaching and shutteling, which tends to kill the cell prematurely. It is believed that the one or more conductive agents assist in effectively trapping the polysulfides in place preventing undesirable effects.

It has been found that coating the conductive agent with a polymer that has an affinity for polysulfides also helps keep the polysulfides in place. Suitable polymers include Nafion, Teflon, polyethylene glycol (PEG), or polyacrylonitrile (PAN).

### First Dopant—a Negatively Charged Organic Polymer

The composite material of the invention preferably comprises the negatively charged organic polymer (first dopant) in an amount of between about 0.5 wt % and about 20 wt %, more preferably in an amount of between about 1 wt % and about 20 wt %. However, in one embodiment, the composite material preferably comprises the negatively charged organic polymer in an amount of between about 0.5 wt % and about 18 wt %, more preferably between about 0.5 wt % and about 18 wt %, and more preferably still, in an amount of between about 2 wt % and about 15 wt %.

The negatively charged organic polymer (first dopant) used in the present invention is preferably a polar polymer where a negative charge is localised on a single atom or spread (delocalised) over multiple atoms. The negatively charged organic polymer (first dopant) is preferably selected from the group consisting of sulfonated or carboxylated polymers, polymeric surfactants, fatty acids, proteins, carboxylated carbon based polymeric structures, and other long chain molecules (e.g. polymers, which can have aromatic groups or otherwise, e.g., have non aromatic groups) with a negative charge, and derivatives thereof, and mixtures thereof. (Within the context of the present invention, polymer, wherein used in relation to a negatively charged organic polymer, include fatty acids, particular long chain fatty acids, having chain lengths of at least greater than 20 carbons.) The negatively charged organic polymer can be used in the acid or the salt form.

In a preferred embodiment, the first dopant comprises a polymer having a backbone that is provided with ionic groups, preferably ionic groups that are electro-withdrawing groups. Suitably, the first dopant comprises a halogenated polymer, preferably such a polymer having sulfonic acid and/or carboxylic acid groups. Suitably, the first dopant comprises a sulfonic acid polymer with a backbone of carbons and electron withdrawing groups such as fluorine or chlorine. In one embodiment, the polymer is a fluorinated sulfonic acid polymer. Sulfonated or carboxylated polymer first dopants are preferred, however, sulfonated polymers are particularly preferred. Thus, preferred first dopant compounds (negatively charged organic polymer) include sulfonated tetrafluoroethylene based fluoropolymer-copolymers, polystyrene sulfonate, polyacrylic acid, and polyethyleneglycol diacid, which can be used in the acid or salt form, particularly alkali salt form, such as the sodium salt. In one embodiment, a salt form of polystyrene sulfonate is preferred, for example, an alkali salt form, particular the sodium salt form. In another embodiment, the acid form of polyacrylic acid is preferred, however, the alkali salt form, particular the sodium salt form is also of interest.

Preferably, when used, the fluorinated sulfonic acid polymer is highly fluorinated, meaning that at least 50% of the total number of halogen and hydrogen atoms in the polymer are fluorine atoms. Suitable fluorinated sulfonic acid polymer includes the commercially available product, available under the tradename of Nafion.™ Nafion™ (sulfonated tetrafluoroethylene based fluoropolymer-copolymer) is a particularly preferred first dopant compound.

Preferably, the first layer of the electrode is deposited electrochemically by passing between 1 Coulomb (C)/area to 50 C charge/area, and more preferably, between 2 C/area and 20 C charge/area, and even more preferably 3 C/area and 7 C charge/area.

### Second Dopant

The second dopant, when present, preferably functions to neutralise the conductive polymer, improve wettability, increase the content of sulfur and/or reduce the resistance of the overall electrode and/or the device. The second dopant is preferably smaller in MW and/or volume than the first dopant.

The second dopant is preferably one or more inorganic salt.

The second dopant preferably comprises a mono-alkali or di-alkaline cation. In a preferred embodiment, the cation may be selected from the group consisting of lithium, sodium and potassium cations, and mixtures thereof. Suitably, the cation is a lithium cation.

The anion of the salt may be any suitable anion including those selected from the anion list (i) to (viii) listed for ionic liquid anions within this specification.

The second dopant preferably comprises small, non-polymeric anions, including bis(alkylsulfonyl)imides, and perfluorinated bis(alkylsulfonyl)imides anions, such as bis(trifluoromethylsulfonyl)imide (TFSI) and/or bis(fluorosulfonyl)imide (FSI) anions. Suitably, the dopant may also comprise sulfate or perchlorate anions.

Thus preferred second dopants salts include LiTFSI, LiSO₄, LiClO₄,and mixtures thereof.

Other preferred second dopant compounds include bulky, non-polymeric organic anions having sulfonic or carboxylic acid groups, including but not limited to anthraquinone sulfonic acid (AQSA), para-toluene sulfonic acid (pTSA), naphthalene sulfonic acid (NapSA), naphthalene di-sulfonic acid (NapDSA), naphthalene tri-sulfonic acid (NapTSA), naphthoic acid, naphthalene acetate, salts of negatively charged metal complexes, such as hexacholorplatinate, and mixtures thereof. In one embodiment, mixtures of the bulkier dopant compound with hydrochloric acid (HCl) are desirable, preferably in 1:1 ratios. For example, in one embodiment, a para-toluene sulfonic acid (pTSA)/HCl mixture gives particular favourable performance, for example, high discharge capacity and/or high sulfur loading on the cathode.

Differences in the various dopants described herein are evident by consideration of their molar masses, for example, the small non-polymeric dopants contemplated herein typically have molar masses of between about 20 to about 150 g/mol, whereas the bulky non-polymeric dopants have higher molar masses of above 150 g/mol, and the polymeric dopants typically have much higher average molar masses of above 5000 g/mol.

It should also be understood that the ratio of the molecular weight of the first dopant to the molecular weight of the second dopant is preferably at least 2, more preferably at least 10, even more preferably at least 100, and yet even more preferably at least 1000.

In a preferred embodiment, the first and second dopants are preferably dispersed within the conductive polymer. The dispersion of the dopants within the conductive polymer is thought to promote a more favourable composite morphology. It will be appreciated that the first dopant polymer of the present invention is present as a non-continuous phase. In other words, a phase or component that is dispersed in a continuous phase, in this case, the conducting polymer body.

The second layer of the electrode, when present, is preferably deposited electrochemically by passing between about 1 Coulomb (C)/area to about 1000 C/area of charge, and more preferably between about 20 C/area and about 750 C/area and even more preferably about 25 C/area and about 550 C/area of charge. In a preferred embodiment, a deposition charge of between about 50 C/area and about 500 C/area is preferred for generating the second layer, with charge values of about 50 C/area, about 100 C/area, about 200 C/area, and about 500 C/area, being of particular interest. In one embodiment, a deposition charge of about 500 C/area is particularly preferred.

### Binders

Binders may be optionally used, particularly in embodiments where chemical deposition means are employed. Suitable binders for the composite material of the invention may be selected from the group consisting of polyvinylacetate, polyvinylalcohol, polyethylene oxide, polyvinyl pyrrolidone, alkylated polyethylene oxide, cross linked polyethylene oxide, polyvinyl ether, poly(methyl methacrylate), polyvinylidene fluoride, a copolymer of polyhexafluoropropylene and polyvinylidene fluoride, poly(ethyl acrylate), polytetrafluoroethylene, polyvinyl chloride, polyacrylonitrile, polyvinylpyridine, polystyrene, polypyrrole, polythiophene, derivatives thereof, blends thereof, copolymers thereof, and combinations thereof.

However, in a preferred embodiment the composite does not contain binders, that is, the material is binder free. In this embodiment, electropolymerisation may be used to fabricate the cathode material, thus providing an electropolymerised cathode material.

### Electrolytes

The electrolyte for the lithium-sulfur electric current producing cell preferably comprises a mixture of an ionic liquid and an organic solvent.

Suitable cations of ionic liquids that can be used herein are described in detail in WO 2004/082059, the relevant contents of which are hereby incorporated by reference. For the purposes of the present invention, pyrrolidinium is a particularly preferred cation for the ionic liquids used herein. Suitably, N-methyl-N-propyl-pyrrolidinium (C₃mpyr) (P13) or N-methyl-N-butyl-pyrrolidinium (C₄mpyr) (P14) cations may be used. Other suitable cations are discussed below.

Suitable anions of ionic liquids that can be used herein are described in detail in WO WO2009/003224, the relevant contents/parts of which are hereby incorporated by reference. Preferred anions for ionic liquids used herein include but are not limited to (bis)sulfonylimides, with particularly preferred anions being either bis(fluorosulfonyl)imide (FSI or FSA), and the most preferred being bis(trifluoromethansulfonyl)imide (TFSI, TFSA, NTf2). In one embodiment, a mixture of anions can be advantageously used to effectively reduce viscosity and increase the conductivity of ionic liquid electrolytes. For example, a mixture of FSI, TFSI, and NO3 anions may be used.

A particularly desirable ionic liquid combination may be selected from C₃mpyr FSI and LiTFSI; C₃mpyr TFSI and LiFSI; C₃mpyr FSI, LiTFSI and LiFSI; or C₃mpyr FSI, LiTFSI, LiFSI and LiNO₃. It will be appreciated that alternative cations to C₃mpyr for these mixtures include those described elsewhere herein, but particularly include (C₄mpyr) P14, which can be used in place of or in combination with C₃mpyr in the ionic liquids for electrolytes disclosed herein.

Preferred lithium concentrations can be achieved by mixing LiTFSI, LiFSI and/or LiNO₃ components in various ratios. For the present invention, the inventors have found that LiTFSI, LiFSI and LiNO₃ mixture ratios of LiFSI: from 0 to 100%, LiTFSI:from 0 to 100%, LiNO₃:from 10% to 25%, and more preferably from about 0.25:0.5:0.25 (respectively) exhibit good performance.

The lithium concentration in a preferred electrolyte is preferably between about 0.2 and about 2 mol·kg⁻¹, more preferably between about 0.5 and about 1.5 mol·kg⁻¹, and even more preferably between about 0.8 and about 1.2 mol·kg⁻¹.

Details of the organic solvent used in the mixtures of the invention are provided below.

The % wt proportion of the ionic liquid to the organic solvent of the electrolyte is preferably from about 90:10 to about 10:90, more preferably from about 80:20 to about 20:80, even more preferably still from about 70:30 to about 30:70 and yet even more preferably from about 70:30 to about 50:50. Particularly preferred electrolytes are 50:50 mixtures of the ionic liquid to the organic solvent.

### Organic Solvent Component

The organic solvent component of the electrolyte preferably comprises one or more solvents selected from the group consisting of glymes, acylic ethers, cyclic ethers, derivatives thereof, and combinations thereof.

Preferred glymes, include those selected from the group consisting of ethylene glycol dimethyl ether (glyme), diethylene glycol dimethylether (diglyme), triethylenglycol dimethyl ether (triglyme), tetraethylene glycol dimethylether (tetraglyme) and higher glymes (for example, CH₃O(CH₂CH₂O)ₙ—CH₃, n>4, polyethers comprising glymes, ethylene glycol divinyl ether, diethylene glycol divinyl ether, triethylene glycol divinyl ether, dipropylene glycol dimethyl ether, butylenes glycol ethers, derivatives and combinations thereof. In one embodiment, triethylene glycol methyl ether (triglyme) (TEGME) or tetraethylene glycol dimethylether (tetraglyme) (TEGDME) is preferred.

Preferred acylic ethers include those selected from the group consisting of dimethylether, di propyl ether, dibutylether, dimethoxy methane, trimethoxymethane, dimethoxyethane, diethoxymethane, 1,2-dimethoxy propane, 1,3-dimethoxy propane, derivatives and combinations thereof.

Preferred cyclic ethers include those selected from the group consisting of tetrahydrofuran, tetrahydropyran, 2-methyltetrahydrofuran, 1,4-dioxane, trioxane, dioxolanes, derivatives and combinations thereof.

Preferred dioxolanes suitable for use in the electrolytes of the present invention include those selected from the group consisting of 1,3-dioxolane, alkyl substituted 1,3-dioxolanes such as 4-methyl-1,3-dioxolane, 4,5-dimethyl-1,3-dioxolane, 2-methyl-1,3-dioxolane, and combinations thereof. Preferred dioxolanes include 4-methyl-1,3-dioxolane, 1,3-dioxolane, and combinations thereof. A preferred dioxolane is 1,3-dioxolane (DOL).

The organic solvent may be a mixture of two or more organic solvents.

Thus one or more organic solvents for such mixtures are preferably selected from the group consisting of dioxolanes and glymes. Preferably, the weight ratio of dioxolanes to glymes is in the range of about 5:1 to about 1:5, more preferably about 3:1 to about 1:1, and most preferably about 2.5:1 to about 1.5:1.

In one embodiment, the organic solvent component comprises from about 10 to about 90% by weight of a dioxolane and from about 10 to about 90% by weight of one or more 1,2-dialkoxyalkanes of 5 or 6 carbon atoms and/or 1,3-dialkoxyalkanes of 5 or 6 carbon atoms. Dioxolane and dimethoxy ethane is one desirable combination.

In another embodiment a preferred organic solvent mixture is a 1,3-dioxolane (DOL) and dimethoxyethane (DME) mixture, for example, a 1:2 mixture.

A preferred organic solvent mixture is a DOL and TEGME mixture, or a DOL and TEGDME mixture, for example, a 2:1 mixture. Such an organic solvent mixture may be used to form an electrolyte by forming a combination with a suitable ionic mixture, for example, forming a mixture with an IL combination, such as P13FSI:LiFSI:NO₃:TFSI. In one embodiment, it is preferred that the electrolyte comprise a 50:50 mixture of the ionic liquid mixture to the organic solvent mixture.

### Ionic Liquid Component

One component of the electrolyte used in the invention is preferably an ionic liquid. Ionic liquids, which are sometimes referred to as room temperature ionic liquids, are organic ionic salts having a melting point below the boiling point of water (100° C.). Several classes of ionic liquids have been identified and are all suitable for use herein.

### Ionic Liquid Cations

It should be appreciated that where the cation component (e.g. the “cation counterion”) of the IL is not particularly specified herein, it may be any of the cations known for use as components of ionic liquids. For example, the cation may be an onium compound, such as an unsaturated heterocyclic cation, a saturated heterocyclic cation or a non-cyclic quaternary cation based on any heteroatom, such as N, B, P or so forth.

The unsaturated heterocyclic cation of the ionic liquid of the electrolyte of the invention encompasses the substituted and unsubstituted pyridiniums, pyridaziniums, pyrimidiniums, pyraziniums, imidazoliums, pyrazoliums, thiazoliums, oxazoliums and triazoliums, two-ring system equivalents thereof (such as isoindoliniums) and so forth. The general class of unsaturated heterocyclic cations may be divided into a first subgroup encompassing pyridiniums, pyridaziniums, pyrimidiniums, pyraziniums, pyrazoliums, thiazoliums, oxazoliums, triazoliums, and multi-ring (i.e., two or more ring-containing) unsaturated heterocyclic ring systems such as the isoindoliniums, on the one hand, and a second subgroup encompassing imidazoliums, on the other.

Two examples of this general class are represented below:

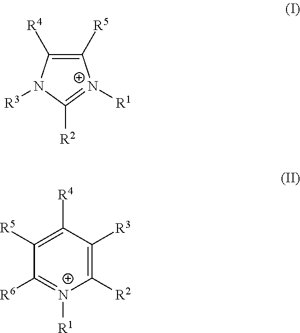

in which R¹ to R⁶ are each independently selected from the group consisting of H, alkyl, haloalkyl, thio, alkylthio and haloalkylthio.

The saturated heterocyclic cation of the ionic liquid of the electrolyte of the invention encompasses the pyrrolidiniums, piperaziniums, piperidiniums, and the phosphorous and arsenic derivatives thereof. Examples of these are represented below:

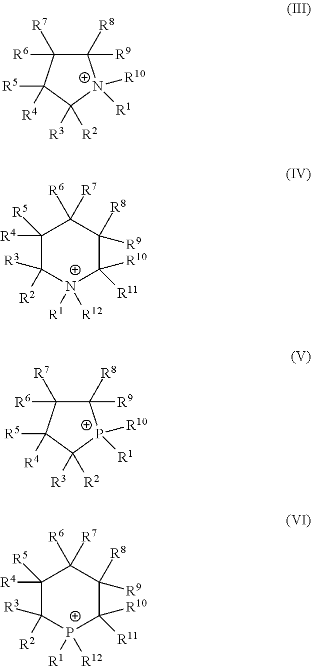

in which:
R¹ to R¹² are each independently selected from the group consisting of H, alkyl, haloalkyl, thio, alkylthio and haloalkylthio.

Specific examples of (III) and (IV) include N-methyl-N-alkyl- pyrrolidinium and N-methyl-N-alkyl-piperidinium, in which the alkyl is a C₁-C₁₂ alkyl, such as a C₃-C₁₂ alkyl or a C₃-C₆ alkyl.

The non-cyclic quaternary cations encompass quaternary ammonium, phosphonium, arsenic and borane derivatives. Examples of these are represented below:

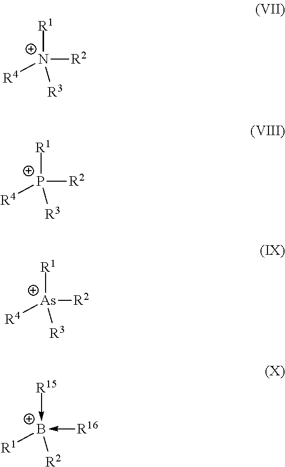

in which:
R¹ to R⁴ are each independently selected from the group consisting of H, alkyl, haloalkyl, thio, alkylthio and haloalkylthio; and
R¹³ and R¹⁴, which are each either a tertiary amine or an N-alkyl imidazole.

Reference is also made to PCT/US2006/019521 (WO 2006/125175) for a detailed description of ionic liquids containing various cations that may be suitably used, the relevant part of which are incorporated herein by reference.

The term “alkyl” is used in its broadest sense to refer to any straight chain, branched or cyclic alkyl groups containing from 1 to 20 carbon atoms and preferably from 1 to 10 carbon atoms. The term encompasses methyl, ethyl, propyl, butyl, s-butyl, pentyl, hexyl and so forth. The alkyl group is preferably straight chained. The alkyl chain may also contain hetero-atoms, and may be optionally substituted by a nitrile group, hydroxyl group, carbonyl group and generally other groups or ring fragments consistent with the substituent promoting or supporting electrochemical stability and conductivity.

Halogen, halo, the abbreviation “Hal” and the like terms refer to fluoro, chloro, bromo and iodo, or the halide anions as the case may be.

Preferred cations for the ionic liquid based electrolytes used herein include 1,3-dialkyl or 1,2,3-trialkyl imidazoliums, 1,1-dialkyl pyrrolidinium and 1,1-dialkyl piperidiniums.

### Ionic Liquid Anions

Where the anion component (e.g. the “anion counterion”) of the IL used in the invention is not particularly specified, it may be any of the anions known for use as components of ionic liquids. The anion may be an unsaturated heterocyclic cation, a saturated heterocyclic cation or a non-cyclic quaternary cation based on any heteroatom, such as N, B, P or so forth. For example, the anion may be selected from the group consisting of:
(i) bis(alkylsulfonyl)imides, and perfluorinated bis(alkylsulfonyl)imides, such as bis(trifluoromethylsulfonyl)imide (TFSI), bis(fluorosulfonyl)imide (FSI) or another of the sulfonyl imides. It is noted that the term “amide” instead of “imide” is sometimes used in the scientific literature. This includes (FSO₂)₂N⁻(CH₃SO₂)₂N⁻, (CF₃SO₂)₂N⁻ (also abbreviated to Tf₂N) and (C₂F₅SO₂)₂N⁻ as examples. The bis imides within this group may be of the formula (CₓY₂ₓ₊₁SO₂)₂N⁻ where x=0 to 6 and Y═F or H;
(ii) boron based anions, including BF₄⁻, perfluorinated alkyl fluorides of boron, orthoborates, and partially fluorinated or perfluorinated borate esters. One sub-class of boron based anions are are B(CₓF₂ₓ₊₁)ₐF₄₋ₐ⁻ where x is an integer between 0 and 6, and a is an integer between 0 and 4. Also encompassed within this class are the fluorinated borate esters, including bis(2,2,3,3-tetrafluoro-1,4-butanediol)borate ester anions (FBDB);
(iii) halides, alkyl halides or perhalogenated alkyl halides of group VA(15) elements; Encompassed within this class is E(CₓY₂ₓ₊₁)ₐ(Hal)₆₋ₐ⁻ where a is an integer between 0 and 6, x is an integer between 0 and 6, y is F or H, and E is P, As, Sb or Bi. Preferably E is P or Sb. Accordingly this class encompasses PF₆⁻, SbF₆⁻, P(C₂F₅)₃F₃⁻ (also known as FAP), Sb(C₂N₃F₃⁻, P(C₂F₅)₄F₂⁻, AsF₆⁻, P(C₂H₅)₃F₃⁻ and so forth;
(iv) CₓY₂ₓ₊₁SO₃⁻ where x=1 to 6 and Y═F or H. This class encompasses CH₃SO₃⁻ and CF₃SO₃⁻ as examples;
(v) CₓF₂ₓ₊₁COO⁻, including CF₃COO⁻;
(vi) sulfonyl and sulfonate compounds, namely anions containing the sulfonyl group SO₂, or sulfonate group SO₃⁻ not covered by groups (i) and (iv) above. This class encompasses aromatic sulfonates containing optionally substituted aromatic (aryl) groups, such as toluene sulfonate and xylene sulfonate;
(vii) cyanamide compounds and cyano group containing anions, including cyanide, dicyanamide and tricyanomethide;
(viii) succinamide and perfluorinated succinamide;
(ix) ethylendisulfonylamide and its perfluorinated analogue;
(x) SCN⁻;
(xi) carboxylic acid derivatives, including CₓHₓ₊₁COO⁻ where x is an integer between 1 and 6.
(xii) weak base anions; and
(xiii) halide ions, such as the iodide ion.

Classes (i) to (vii) are preferred. Classes (i), (ii) and (iii) are particularly preferred.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Unless the context clearly requires otherwise, the term “about” typically means ±5% of the stated value unless specifically stated otherwise. Furthermore, where used in conjunction with a stated value, the term “up to” is inclusive of the stated value, for example, “up to 10” is inclusive of “10”, but exclusive of “zero”.

It should also be understood that the term “between” used in the context of a numerical range includes the recited numerical endpoints, and all intermediate values.

### BRIEF DESCRIPTION OF THE FIGURES

FIG. 1A depicts SEM images of a carbon fiber cloth coated with a single layer of PPy conducting polymer using Nafion and Na₂SO₄ as first and second dopants respectively in the absence of sulfur.

FIG. 1B depicts charge-discharge capacities of cathode shown in FIG. 1A (solid line CC, dashed line DC at C/10).

FIG. 2 depicts an SEM image of the coated carbon fibre cloth with a single layer of the polymer-sulfur composite of comparative example C4 (Ppy/S/Nafion/cb/Li₂SO₄), but using nano sulfur instead of S.

FIG. 3 depicts an SEM image of the coated carbon fibre cloth coated with the two layers polymer sulfur composite of comparative example E1 formed using two step electropolymerisation.

FIG. 4 depicts a voltage-time profile of a Li—S battery using S cathodes prepared by two step electropolymerisation (E1) at a C/100 rate at room temperature.

FIG. 5 depicts charge-discharge capacities and energy and power profiles (solid line CC; long dashed line (DC), dotted line is energy and dashed line is power) of a battery cell consisting of Li metal anode, sulfur cathode, ionic liquid/organic solvent electrolyte (E1) at a C/100 rate at room temperature.

FIG. 6 depicts charge-discharge capacities and energy and power profiles (solid line CC; long dashed line (DC), dotted line is energy and dashed line is power) of a battery cell consisting of Li metal anode, sulfur cathode, ionic liquid/organic solvent electrolyte (E1) at a C/10 rate at room temperature. FIG. 7 depicts the effect of different electrolytes on discharge capacities at C/100 of S cathodes C1 (dashed line), C2 (dotted line), C3 (solid line) shown in Table 2.

FIG. 8 depicts the effect of carbon black and carbon nanotubes-S added to the electropolymerisation mixture on discharge capacities C/100 of S cathodes C4 (dashed line), C5 (dotted line) and C6 (solid line) shown in Table 2.

FIG. 9 depicts the effect of sulfonated organic dopants in the second step electropolymerisation on discharge capacities of S cathodes E5 (solid line), E6 (dashed line), E7 (dotted line) shown in Tables 3 and 4.

FIG. 10 depicts the effect of polymeric dopants in the first step electropolymerisation on discharge capacities of S cathodes shown in Tables 3 and 4. E10 (solid line), E12 (dotted line), E13 (dashed line).

FIG. 11 depicts the effect of charge consumed during electropolymerisation on discharge capacities of S cathodes E14 (solid line), E15 (dotted line), E16 (dashed line) and E17 (long dashed line) shown in Tables 3 and 4.

FIG. 12 depicts SEM images of SS mesh coated with a first layer by applying 0.9 V for 5 C using 0.25% Nafion, 2 mg/ml CB and 0.2 M pyrrole (without sulfur).

FIG. 13 depicts SEM images of SS mesh coated with a first layer by applying 0.9 V for 5 C using 0.25% Nafion, 6 mg/ml S flakes, 2 mg/ml CB and 0.2 M pyrrole.

FIG. 14 depicts SEM images of SS mesh coated by applying 0.8 V for 500 C using 0.1 M Li₂SO₄, 2 mg/ml CB and 0.2 M pyrrole (without sulfur/Nafion).

FIG. 15 depicts SEM images of SS mesh coated by applying 0.8 V for 500 C using 0.1 M Li₂SO₄, 6 mg/ml S flakes, 2 mg/ml CB and 0.2 M pyrrole (without Nafion).

FIG. 16 depicts SEM images of SS mesh coated by applying 0.8 V for 500 C using 0.25% Nafion, 0.1 M Li₂SO₄, 2 mg/ml CB and 0.2 M pyrrole (without sulfur) (with first and second dopants).

FIG. 17 depicts SEM images of SS mesh coated by applying 0.8 V for 500 C using 0.25% Nafion, 0.1 M Li₂SO₄, 6 mg/ml S flakes, 2 mg/ml CB and 0.2 M pyrrole (with first and second dopants). (C5)

FIG. 18 depicts SEM images of SS mesh coated with a first layer by applying 0.9 V for 5 C using 0.25% Nafion, 2 mg/ml CB and 0.2 M pyrrole, then a second layer with 0.1 M Li₂SO₄ added and apply 0.8 V for 500 C. (without sulfur)

FIG. 19 depicts SEM images of SS mesh coated with a first layer by applying 0.9 V for 5 C using 0.25% Nafion, 6 mg/ml S flakes, 2 mg/ml CB and 0.2 M pyrrole, then a second layer with 0.1 M Li₂SO₄ added and apply 0.8 V for 500 C. (E1)

FIG. 20 depicts charge-discharge capacities of conventional cathode comprising 50% wt S, 40% wt Carbon black and 10% wt PVDF binder and utilising 100% P14TFSI as electrolyte (solid line CC, dashed line DC at C/10).

FIG. 21 depicts an image reflecting the large contact angle of the 100% IL electrolyte and poor wettability upon contact with cathode and separator.

### DETAILED DESCRIPTION

The lithium-sulfur electric current producing cell of the invention comprises an electrolyte interposed between the cathode and the anode. The electrolytes function as a medium for the storage and transport of ions.

The Li/S electric current producing cell according to the present invention may further contain a separator between the anodic and the cathodic region of the cell. Typically, the separator is a porous non-conductive or insulative material which separates or insulates the anodic and the cathodic region from each other and which permits the transport of ions through the separator between the anodic and the cathodic region of the cell. The separator is usually selected from the group consisting of porous glass, porous plastic, porous ceramic and porous polymer separators.

The lithium-sulfur electric current producing cell may further comprise a current collector which further acts as current supply in the charge mode of the electric current producing cell. The current collector/current supply may be prepared from conductive materials, such as stainless steel, carbon, aluminium, copper, titanium or mixtures thereof.

The use of conductive polymer-sulfur composites as cathodes for Li—S batteries has been widely applied and utilised. The advantage of adding conductive polymer to the composite includes but is not limited to improved electrical conductivity, as well as improved charge and discharge capability, since the conductive polymers can participate in the redox process. They also act as a binder and adsorber of the cathode components and hence insuring good mechanical stability of the cathode during the cycling process of the battery.

One preparation of conductive polymer-sulfur composites involves a chemical synthesis approach by using a known concentration of the monomer with sulfur dispersed in the mixture followed by polymer formation by adding an oxidiser such as Fe³⁺ or H₂O₂ along with a dopant (an anion). Then typically certain amount of this composite is mixed with a conductive agent (e.g. carbon black) and a binder, such as PVDF, and the slurry is cast to make the cathode.

However, preferably, the polymer-sulfur composites of the invention are applied to a suitable support using electrochemical polymerisation (or electropolymerisation) without having to add additional binders. The electropolymerisation mixture preferably includes the monomer along with sulfur, conductive agent (e.g. carbon) and one or more of the desired dopants as described herein.

Advantageously, the use of an electropolymerisation method creates conductive polymer sulfur composite material/cathodes in one or two steps, whereby sulfur is added to the electropolymerisation mixture and electropolymerised onto electrically conductive supports such as carbon fibre cloth, carbon ink coated aluminium foil, gold sputtered aluminium foil and stainless steel mesh, etc. This approach enables increased loading of the active material onto the conductive support. It also enables better encapsulation and protection of sulfur onto the conductive support. This protection enhances the stability and cyclability of the charge/discharge process of the battery. Moreover, different additives that can improve the performance and stability of the battery can easily be added to the electropolymerisation mixture. This technique results in enhanced battery performance using sulfur and other materials while reducing operation time and cost compared to chemical methods of preparation.

### EXAMPLES

Examples 1 to 8 (C1 to C8) involve single step electropolymerisation to form the active electrode materials, while example 1 (E1) involves a two step electropolymerisation process using stainless steel mesh (mesh 400) substrate (Tables 1 and 2). As shown in the Figures, utilising a second electropolymerisation process provides an improved coating on the substrate, typically having a higher S loading and improved porosity, leading to superior performance in particular to with respect to discharge capacity. In general, cathodes prepared by the two electropolymerisation approach show higher discharge capacity upon cycling at C/10 for 100 cycles.

Additional examples (E2-E17) involving two step electropolymerisation using stainless steel mesh substrate are detailed in Tables 3 and 4.

Carbon fibre cloth (3×6 cm) (7 μm diameter graphitised) was treated with air plasma for 3 min on each side at 900 W or a stainless steel mesh (mesh 400) (3×6 cm) (32 μm diameter) were used as a substrate for growing the conductive polymer. 0.2 M pyrrole was used for preparing the composite materials. Different forms of sulfur were used in the mixture such as micro sulfur nano sulfur and sulfur flakes at a concentration of 5 mg/ml or higher.

Different bulky anionic dopants used for the first step electropolymerisation at 0.25% wt/wt concentration such as Nafion™, polystyrene sulfonate, polystyrene sulfonic acid and polyacrylic acid in acid or salt forms. Also different small, non-polymeric dopants were used for the second step electropolymerisation at 0.1 M concentration, such as sodium dodecyl benzenesulfonate (SDBS), lithium sulphate (Li₂SO₄), LiTFSI, anthraquinone sulfonic acid (AQSA), naphthalene sulfonate (NapSA), p-toluene sulfonate (pTSA) and LiClO₄ or mixtures of these with HCl.

Different forms of carbon were used such as carbon black (CB) (2 mg/ml) and carbon nanotubes pre-infused with S (10 mg/ml). Multi-walled carbon nanotubes with adsorbed sulfur were prepared by heating vacuum sealed tubes containing MWCNT and sulfur (1:2) (67 wt % S and 33 wt % MWCNT) to 160° C. for 10 hrs.

For single step electropolymerisation preparation of the cathode, the substrate was inserted into a mixture containing pyrrole, sulfur (or MWCNT coated with sulfur), carbon black and dopant(s) and then a fixed potential was applied for a certain period of time (1 hr) without stirring the solution. Then the cathode was removed, washed with de-ionised water and dried at room temperature overnight.

For the two step electropolymerisation cathode preparation, the first step was initiated by using one of the above described polymeric dopants, such as Nafion, passing through a fixed amount of charge (C) which was followed by the second step of electropolymerisation, using one of the second dopants detailed above, again by passing a fixed amount of charge (C) to control the layer thickness and electrode capacity.

### Abbreviations (Unless Stated Elsewhere)

PPy: Polypyrrole; MW: Multiwalled Carbon nanotube; S: Sulfur; MW-s: MWCNT coated with sulfur; CB: Carbon black; CC: Charge capacity; DC: Discharge capacity; IL: Ionic liquid; SDS: Sodium dodecyl sulphate; SDBS: Sodium dodecyl benzene sulfonate; PSS: Polystyrene sulfonate; PAA: Polyacrylic acid; PMMA: Polymethylmthacrylate; AQSA: Anthraquinone sulfonic acid; p-TSA: Para-toluene sulfonic acid; and NapSA: Naphthalene sulfonic acid.

### Results

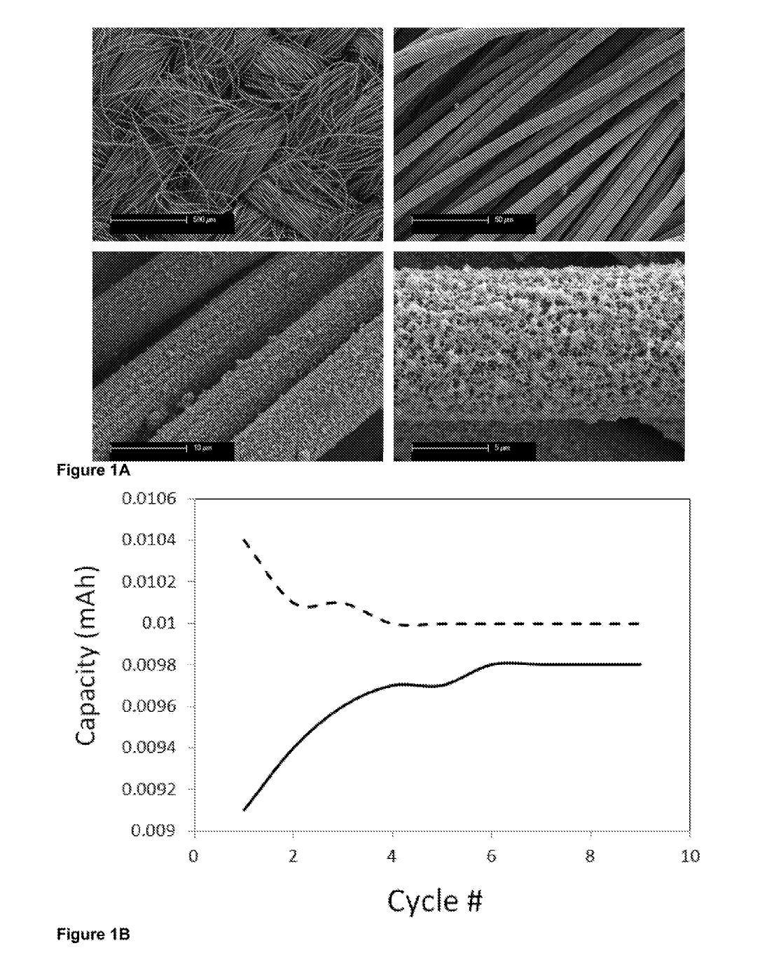

As illustrated in the Figures, single step electropolymerisation of pyrrole in presence of an inorganic dopant salt, such as Li₂SO₄, both with and without sulfur, leads to the formation of compact films of conductive polymer polypyrrole which are aligned along the carbon fibre cloth filaments of the cathode support (in particular see FIGS. 1 (without S) and 2 (with nano-S)). (It should be noted that stainless steel mesh can also be used).

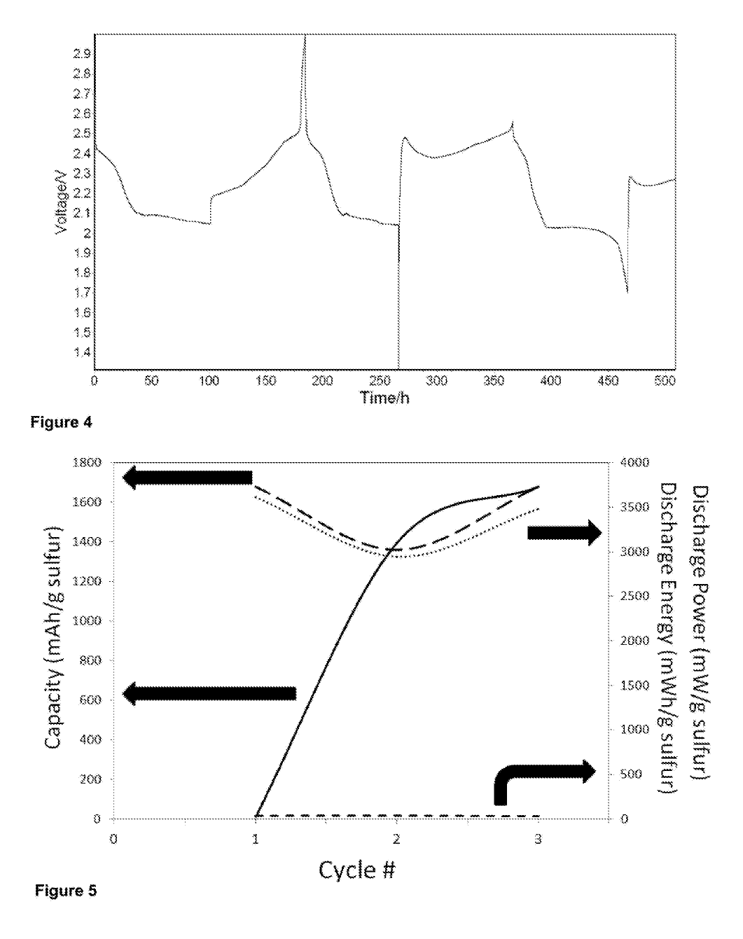

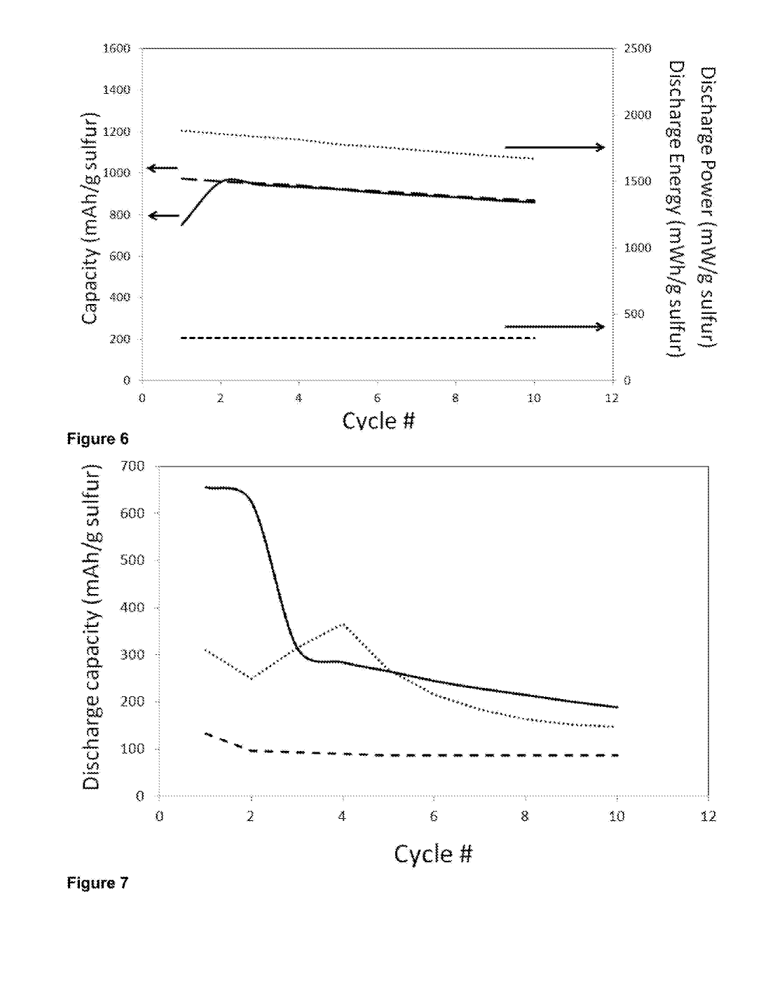

On the other hand, two step electropolymerisation of pyrrole in presence of bulky polymeric polymeric dopants, such as Nafion, on a carbon fibre cathode support, followed by a second electropolymerisation step in presence of a small second dopant, such as Li₂SO₄, leads to the formation of a rough polpyrrole coating that covers most of the carbon fibre support and fills the space in between (see FIG. 3). This latter coating shows higher degree of porosity compared to the film prepared by the former single step electropolymerisation. In addition the electrochemical performance of this cathode is much better, i.e. shows a higher discharge capacity, when compared to other cathodes prepared by single step electropolymerisation (Table 2, e.g., see E1 v C7). Battery cycling results are shown in FIGS. 4, 5 and 6. Thus, in certain embodiments of the invention, preferred cathodes are two layer cathodes formed from a two step electropolymerisation process, particularly, involving a bulky first dopant in the first layer, and a smaller second dopant in the second layer.

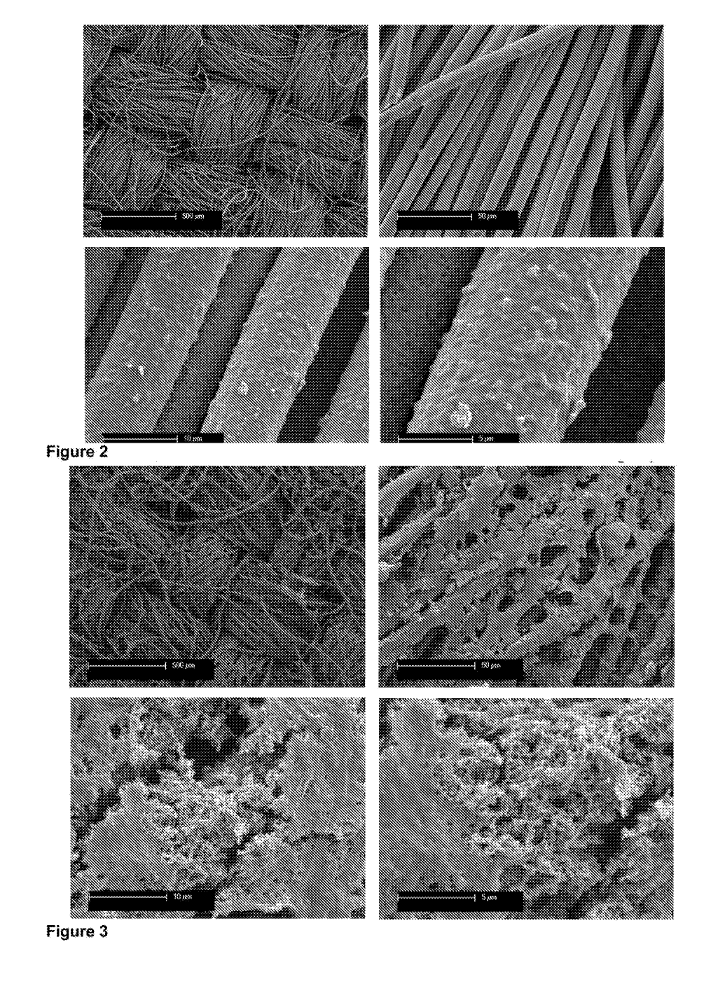

Cathodes prepared by single step electropolymerisation involving negatively charged second dopants, such as the surfactants SDBS and SDS, tended to show poorer performance, believed to be due to poorer wettability of electrolyte (containing 100% IL) and weaker interaction with the C₃mpyr FSI and C₄mpyr TFSI ionic liquids. Using second dopants such as LiTFSI, Li₂SO₄ and LiClO₄ (FIGS. 1 and 2) led to improved wettability and battery discharge capacity. However, none of these cathodes were able to cycle more than 50% of the electrodeposited sulfur component. This was attributed to the high content of sulfur in these cathodes (>25%) which led to higher electrical resistance. Based on this, the content of sulfur in the cathode was decreased to 1-2 mg sulfur per cathode. Even after doing this the performance of these cathodes showed mostly the redox activity of the conductive polymer but not for sulfur. It was assumed that, even though the IL appears to wet the cathode, there is a possibility that wetting occurs only on the surface of the conductive polymer but does not reach the inner components which are encapsulated by the conductive polymer, e.g. sulfur. Therefore, rather than using 100% IL as the electrolyte, the composition was adjusted to 50% IL and 50% organic modifier such as DOL, DME and TEGDME, or combinations thereof. With the new electrolyte mixtures, the cathodes perform better and clearly show activity for sulfur redox reactions. Further improvement in the performance of the cathodes with the new electrolytes was achieved by adding carbon black to the electropolymerisation mixture and also by using carbon nanotubes infused with sulfur instead of using flake or particulate sulfur alone.

The most significant improvement to the cathode performance was made by utilising a two step electropolymerisation protocol where the first step uses a bulky dopant as described above, such as Nafion, to prepare a thin layer of the conductive polymer followed by an additional coating of the conductive polymer using a small non-polymeric second dopant as described above, such as LiTFSI or Li₂SO₄ (see FIGS. 3-6) This led to higher loading of sulfur and higher, more stable charge and discharge capacities. It is apparent that the presence of the bulky polymeric dopants on the substrate surface allows better interaction with sulfur and at the same time minimises the leaching of polysulfide from the cathode Table 2 below summarises some of these results.

Further optimisation of the cathode construction and performance was achieved by testing other bulky dopants for the first electropolymerisation step, for example, PSS and PAA (acid and salt forms) (Tables 3 and 4). In addition different bulkier organic dopants such as sulfonated organic dopants including AQSA, p-TSA and NapSA were investigated as second dopant in the second electropolymerisation step (Tables 3 and 4). Finally the effect of different type and quantities (ratios) of sulfur was also investigated as shown in Tables 3 and 4.

### SINGLE STEP ELECTROPOLYMERISATION EXAMPLES

### Example 1

### Effect of Electrolyte Composition with Single Step Electropolymerisation

This work started with using 100% of ionic liquid as the electrolyte in the test model. This however showed poorer performance thought to be due to high viscosity and poor wettability with the cathode. In addition the high viscosity of the 100% IL electrolyte leads to low ionic mobility and hence conductivity which greatly affect the overall performance, and limit high charge and discharge capacities. An enhancement was made by using a mixture of 50% IL and 50% organic solvent which led to improved performance due to enhanced ionic conductivity and mobility that resulted in better wettability. FIG. 21 shows an image reflecting the large contact angle of the 100% IL electrolyte and poor wettability upon contact with cathode and separator. It should be noted that electrolytes consisting of 100% ionic liquid do not achieve the desired wettability, as measured by the apparent contact angle of the cathode surface with the electrolyte, of less than 20° degrees at time=10 seconds (after wetting), and more preferably is less than 10° degrees after 10 seconds (after wetting). In contrast, the preferred electrolytes of the invention comprising 50% ionic liquid: 50% organic solvent, as described herein, achieve a wettability, as measured by the apparent contact angle of the cathode surface with the electrolyte, of less than 20° degrees at time=10 seconds (after wetting), and more preferably is less than 10° degrees after 10 seconds (after wetting).

A comparison of discharge capacities of these different electrolytes is shown in FIG. 7.

### Example 2

### Effect of Addition of Carbon and Carbon Nanotubes with Adsorbed Sulfur to the Electropolymerisation Mixture with Single Step Electropolymerisation

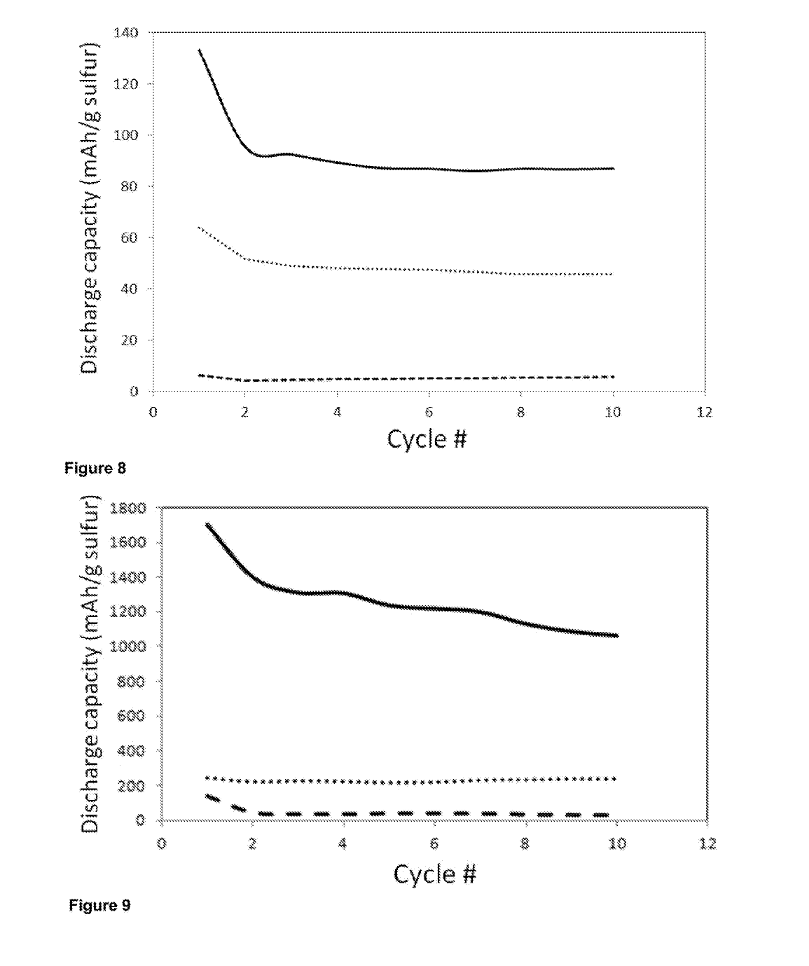

The addition of carbon based materials to the electropolymerisation solution serves two purposes. The first is to enhance the dispersion of sulfur in the solution and to minimise its aggregation and the second to enhance the electrical conductivity of the cathode and to enhance the electrical communication with larger amount of sulfur in the cathode. Further improvement of performance in the test models were observed by using sulfur adsorbed on MWCNT instead of using sulfur and carbon separately as shown in FIG. 8.

### TWO STEP ELECTROPOLYMERISATION EXAMPLES

### Example 1

### Effect of Different Small Dopants in the Second Electropolymerisation Step

In order to improve the resistance of the prepared cathode and also to increase the loading of S in these cathodes, other sulfonated organic second dopants were tested. Those included AQSA, p-TSA and NapSA. These dopants were used either alone or as 1:1 mixture with HCL at 0.1 M for both. Results show that cathodes prepared without HCl show lower capacities possibility due to blocking of S by a thick layer of conductive polymer and/or poor porosity. While those prepared in presence of HCl showed higher capacities especially for pTSA. AQSA did not show high loading of S onto the cathode due to poor solubility.

### Example 2

### Effect of Different Polymeric First Dopants in the First Electropolymerisation Step

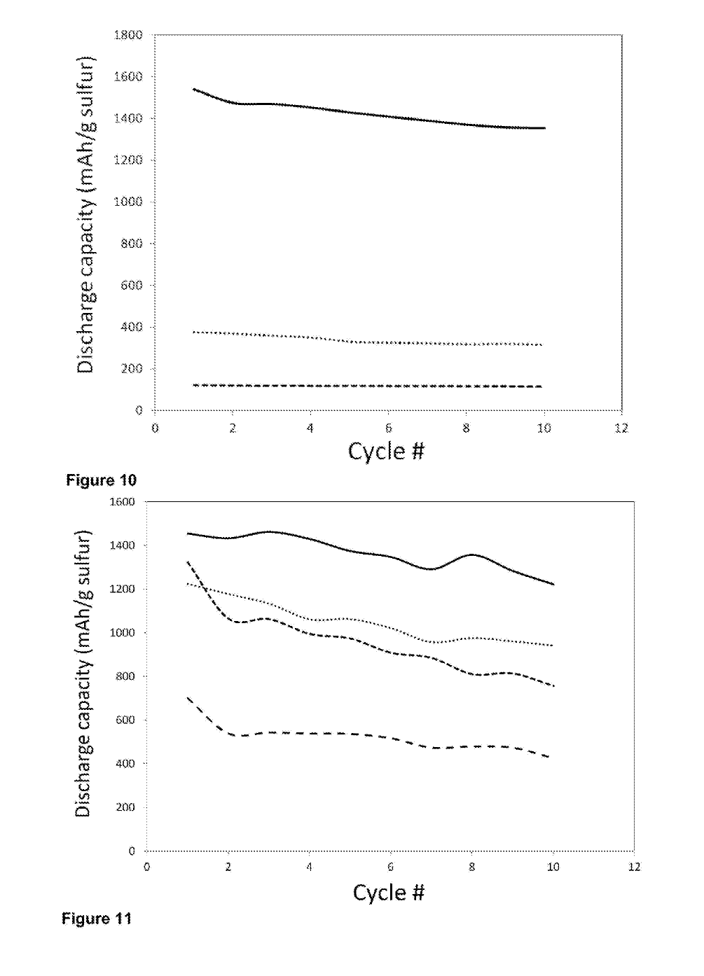

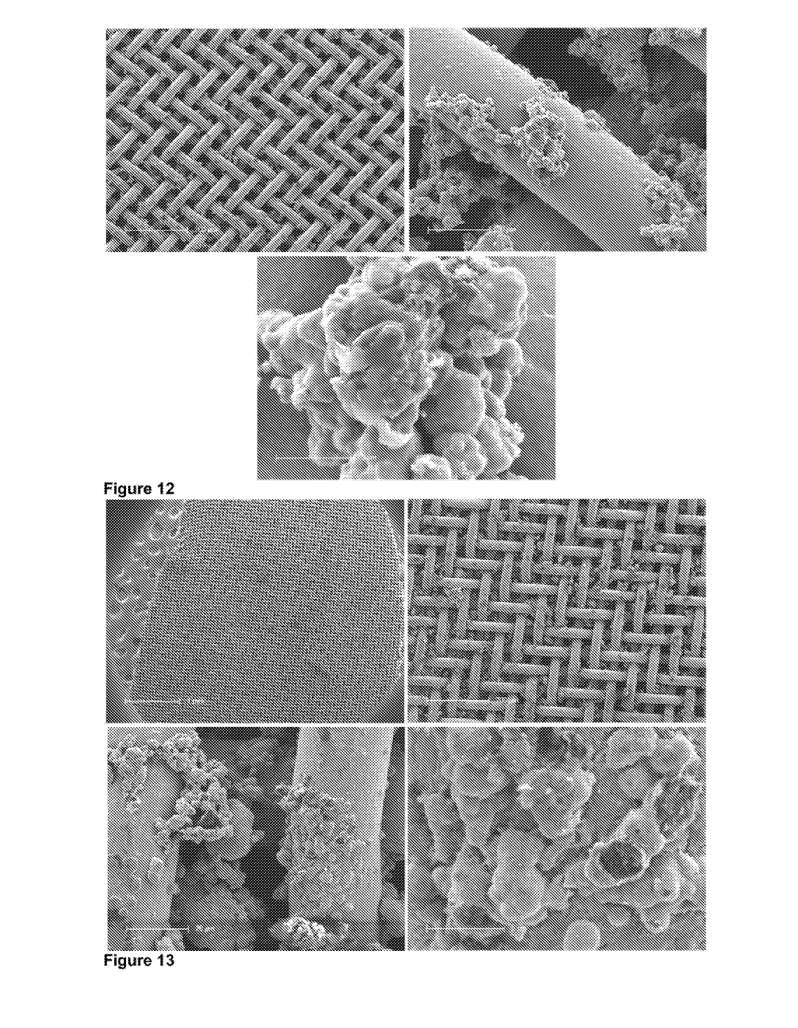

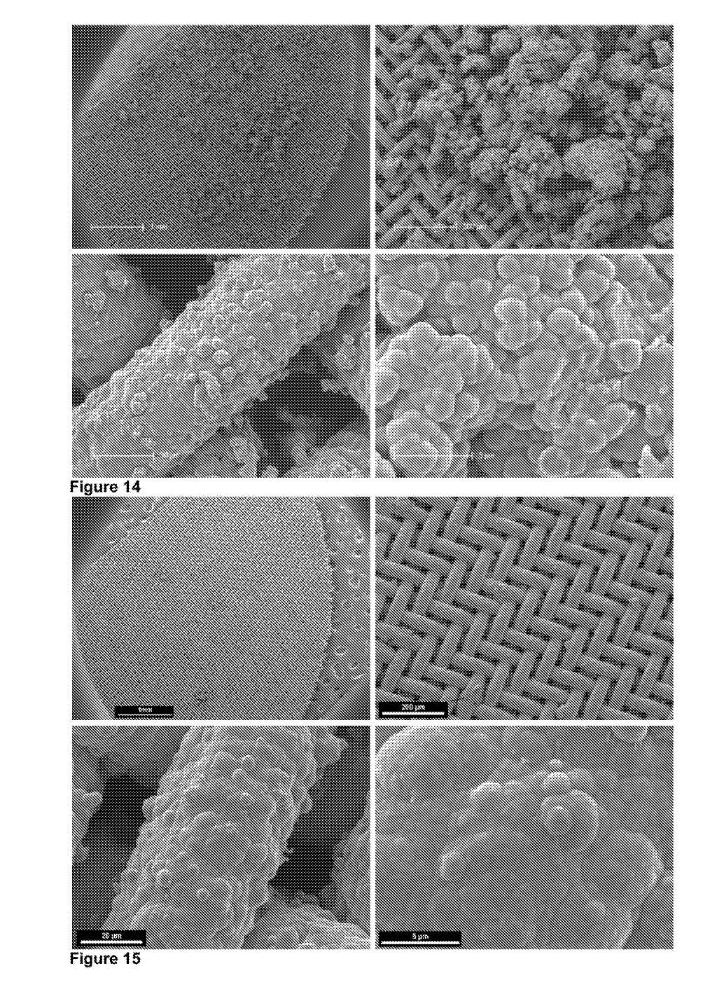

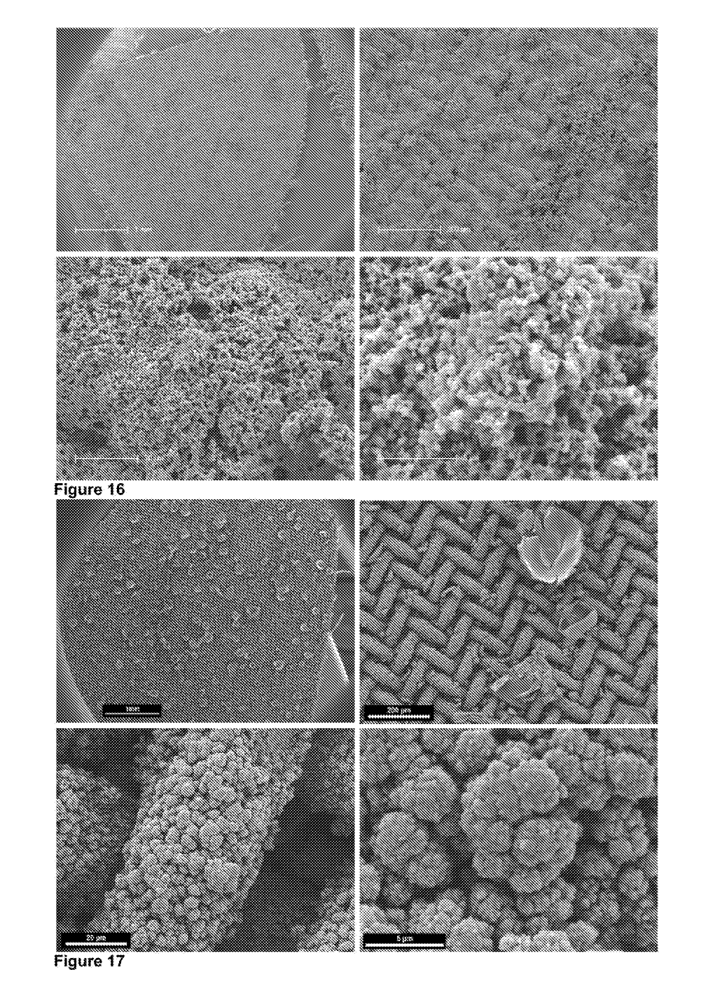

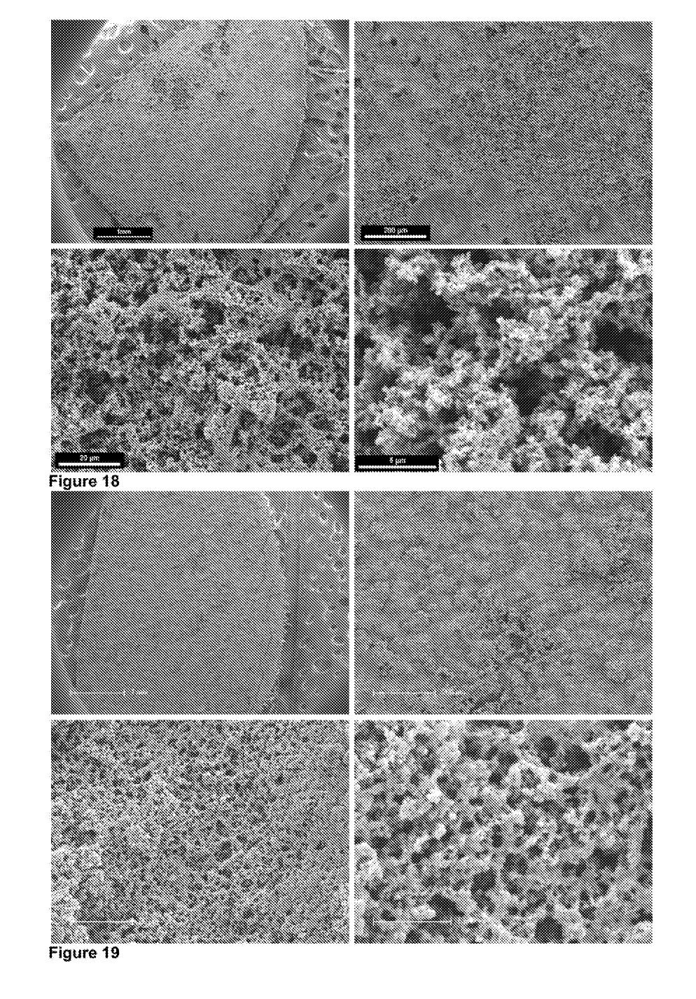

In addition to Nafion, other negatively charged polymeric dopants were tested as a dopant in the first step electropolymerisation as shown in FIG. 10. Those included PSS, PAA and PMMA. The acid and sodium based polymers were tested. While PSS gave a smooth and uniform coating in the test model used, PAA gave a rough and non-uniform coating. In the test systems used, higher content of sulfur could be incorporated when PAA was used while higher discharge capacities were obtained when PSS.Na was used.

### Example 3

### Effect of Different Electropolymerisation Charge During the Second Electropolymerisation Step

The effect of charge consumed during the electropolymerisation process can affect the ratio of S in these cathodes with the highest ratio obtained when small charge was passed. On the other hand, the highest discharge capacity was obtained when the highest amount of charge was used which is probably due to better electrical interaction between sulfur and the conductive polymer when the ratio of PPY to sulfur was high.

Table 3 and Table 4 indicate the compositions used and performance under certain test conditions. As the result indicate, and due to the complexity of the cells, components and electrolytes thereof, there are many factors that affect performance; however, the skilled person, coupled with the disclosure provided herein, will be able use the teachings of the invention to readily achieve a cell with the required performance, depending on a desired application and associated performance criteria.

### General Method for Making Layers

The S cathodes were prepared by two step electropolymerisation. In the first step a solution containing sulfur, carbon black, first polymeric dopant and pyrrole was used where a conductive support is immersed in this solution and electropolymerisation is initiated by applying a potential for a certain amount of charge. Then after the completion of the first step, the second step is initiated by adding the second dopant to this mixture and then electropolymerisation is initiated by applying potential for a certain amount of charge

Before preparation of cathodes the carbon cloth supported was treated by air plasma for 1 min at 900 Watt. The electropolymerisation mixture solution containing all components was sonicated for 2 hrs before any electropolymerisation was performed.

All cathodes were dried under vacuum at 40° C. for 3 days prior to being pressed at 0.25 tonnes/cm². Electrode discs of 13 mm diameter, a 13 mm lithium metal counter electrode and 17 mm diameter Solupor 7P separator were punched before being assembled into a 2032 coin cell (Hohsen, Japan) in Argon glovebox (<5 ppm H₂O, O₂). The electrolyte used is as described in Table 4 with a known volume of 40 μL. For the forthcoming examples, based on earlier work we have fixed the electrolyte used. All cells were cycled on a Maccor Series 4000 battery tester at room temperature.

TABLE 1
Electrodeposition solutions for single layer only

| | |
|---|---|
| # | Electropolymerisation components (wt %)* and deposition conditions |

Single Layer

| | |
|---|---|
| C1 | Pyrrole: 34.4%, MW-S: 25.7%, Nafion: 6.4%, Carbon black: |
| | 5.1, Li₂SO₄: 28.3%, 1 hr at 1.2 V |
| C2 | Pyrrole: 34.4%, MW-S: 25.7%, Nafion: 6.4%, Carbon black: |
| | 5.1, Li₂SO₄: 28.3%, 1 hr at 1.2 V |
| C3 | Pyrrole: 34.4%, MW-S: 25.7%, Nafion: 6.4%, Carbon black: |
| | 5.1, Li₂SO₄: 28.3%, 1 hr at 1.2 V |
| C4 | Pyrrole: 40.7%, S: 18.2%, Nafion: 7.6%, Li₂SO₄: 33.4%, |
| | 1 hr at 1.2 V |
| C5 | Pyrrole: 38.4%, S: 17.2%, Nafion: 7.2%, Carbon black: |
| | 5.7%, Li₂SO₄: 31.5%, 1 hr at 1.2 V |
| C6 | Pyrrole: 34.4%, MW-S: 25.7%, Nafion: 6.4%, Carbon black: |
| | 5.1, Li₂SO₄: 28.3%, 1 hr at 1.2 V |
| C7 | Pyrrole: 38.4%, S: 17.2%, Nafion: 7.2%, Carbon black: |
| | 5.7%, Li₂SO₄: 31.5%, 1 hr at 1.75 V |
| C8 | Pyrrole: 34.4%, MW-S: 25.7%, Nafion: 6.4%, Carbon black: |
| | 5.1, Li₂SO₄: 28.3%,, 1 hr at 1.75 V |

Two layer

| | |
|---|---|
| E1 | Pyrrole: 56.1%, S: 25.1%, Nafion: 10.5%, Carbon black: |
| | 8.4%, 1 hr at 1.75 V, then additional electropolymerisation |
| | in Pyrrole: 38.4%, S: 17.2%, Nafion: 7.2%, Carbon black: |
| | 5.7%, Li₂SO₄: 31.5%, at 1.75 V for 1 hr |

*calculated from starting solutions;
C = examples using one layer

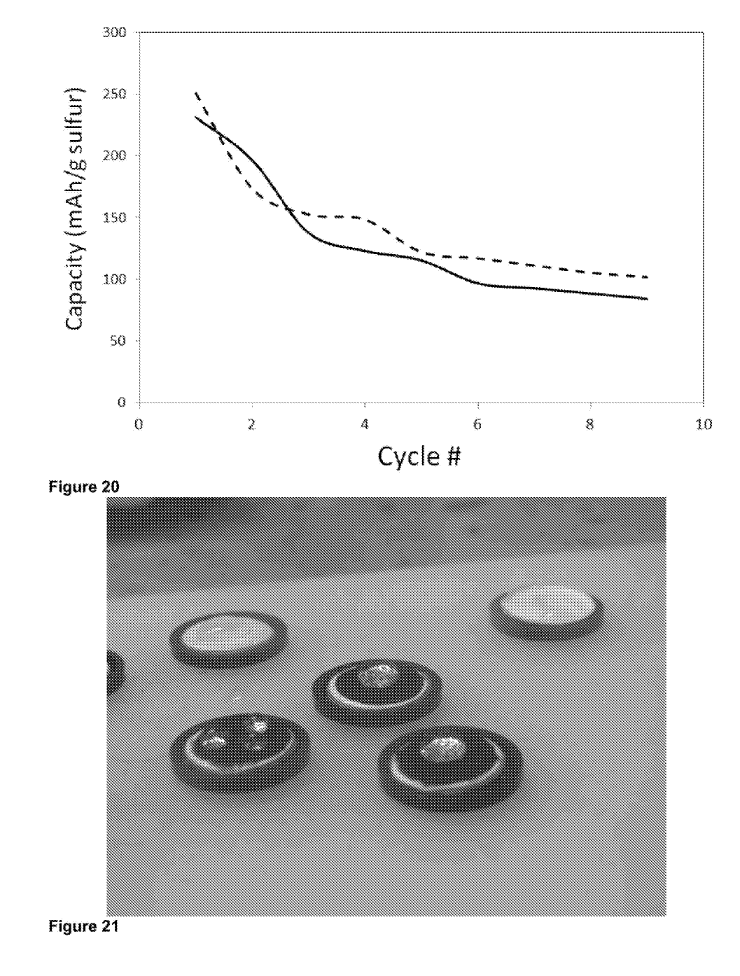

TABLE 2
Charge capacities (CC) and discharge capacities (DC) at various cycle using a conventional S cathode (C/10) different
cathodes of the invention and electrolytes (all electrodes have approximately 1 mg S based on S extraction test (C/100, C/10)

| Cathode | | CC (mAh/g) | DC (mAh/g) | CC (mAh/g) | DC (mAh/g) |
|---|---|---|---|---|---|
| Electrode | Electrolyte | 1^{st}, 9^{th} | 1^{st}, 9^{th} | 2^{nd}, 9^{th} | 2^{nd}, 9^{th} |
| Conventional | 100% P14IFSI | 231, 84 | 250, 101 | 197, 84 | 173, 101 |
| cathode (FIG. 20) C/10 | | | | | |

| | | | | | | |
|---|---|---|---|---|---|---|
| Cathode | | Wt | CC (mAh/g) | DC (mAh/g) | CC (mAh/g) | DC (mAh/g) |
| Electrode | Electrolyte | active | 1^{st}, 10^{th} | 1^{st}, 10^{th} | 2^{nd}, 10^{th} | 2^{nd}, 10^{th} |

Single layer

| | | | | | | | |
|---|---|---|---|---|---|---|---|
| C1 | PPy/MW-S/ | P13FSI, 0.4M LiTFSI, 0.6M LiFSI | 6.2 Mg | 38, 74 | 133, 87 | 68, 74 | 96, 87 |
| | Naf/CB/Li₂SO₄ | | | | | | |
| C2 | PPy/MW-S/ | 50% P13FSI, 0.5M LiFSI, | 9.5 mg | 11, 157 | 311, 146 | 229, 157 | 249, 146 |
| | Naf/CB/Li₂SO₄ | 0.25M NO₃, 0.25M LiTFSI | | | | | |
| | | 50% DOL/TEGME (2:1) | | | | | |
| C3 | PPy/MW-S/ | 50% P13FSI, 50% DOL/DME (1:2), | 6.3 mg | 8, 183 | 660, 189 | 295, 183 | 625, 189 |
| | Naf/CB/Li₂SO₄ | LiFSI, LiNO₃, LiTFSI | | | | | |
| C4 | PPy/S/Naf/Li₂SO₄ | P13FSI, 0.4M LiTFSI, 0.6M LiFSI | 3.75 mg | 1.2, 5.1 | 6.4, 5.7 | 2.6, 5.1 | 4.2, 5.7 |
| | 1.2 V 1 hr | | | | | | |
| C5 | PPy/S/Naf/CB | P13FSI, 0.4M LiTFSI, 0.6M LiFSI | 6.54 mg | 34.8, 41.8 | 63.9, 45.8 | 35, 41.8 | 63.9, 45.8 |
| | Li₂SO₄ 1.2 V 1 hr | | | | | | |
| C6 | PPy/MWS/Naf/CB | P13FSI, 0.4M LiTFSI, 0.6M LiFSI | 7.0 mg | 38, 73.9 | 133, 87.1 | 68, 73.9 | 96, 87.1 |
| | Li₂SO₄ 1.2 V 1 hr | | | | | | |
| C7 | PPy/S/Naf/CB | 50% P13FSI, LiFSI, NO₃, TFSI | 10.4 mg | 15, 47 | 61, 46 | 43, 47 | 46, 46 |
| | Li₂SO₄ 1.75 V 1 hr | 50% DOL/TEGME (2:1) | | | | | |
| C8 | PPy/MWS/Naf/CB | 50% P13FSI, LiFSI, NO₃, TFSI | 15 mg | 10, 63 | 133, 75 | 86, 63 | 105, 75 |
| | Li₂SO₄ 1.75 V 1 hr | 50% DOL/TEGME (2:1) | | 18, 13 | 13, 13 | | |
| | | | | (C/10) | (C/10) | | |

Two layer

| | | | | | | | |
|---|---|---|---|---|---|---|---|
| E1 | PPy/S/CB/Naf | 50% P13FSI, LiFSI, NO₃, TFSI | 14.2 mg | 9, 1678 | 1678, 1678 | 1394, 1678 | 1358, 1678 |
| | PPy/S/CB/Li₂SO₄ | | | (C/100)* | (C/100)* | (C/100)** | (C/100)** |
| | Li₂SO₄ 1.75 V | 50% DOL/TEGME (2:1) | | 752, 861 | 975, 869 | 959, 861 | 962, 869 |
| | | | | (C/10) | (C/10) | (C/10) | (C/10) |

*Cycle 1, 3
**Cycles 2, 3

TABLE 3
Two Layer Electrode composition/structure

| | | | | | | | S cathode | |
|---|---|---|---|---|---|---|---|---|
| | Conductive | Sulfur | First Layer | | Second Layer | | loading | Resist |
| # | Polymer | (type/wt %) | First Dopant | Charge (C) | Second Dopant | Charge (C) | (mg) | Ω/cm |

Baseline system

| | | | | | | | | |
|---|---|---|---|---|---|---|---|---|
| E1 | Polypyrrole (ppy) | Flakes 5% | Nafion (0.25%) | 5 (0.9 V) | Li₂SO₄ | 500 | 14 | 10 |
| | (0.2M) | (6 mg/ml) | | | | (0.8 V) | | |

Effect of different dopants on the second layer

| | | | | | | | | |
|---|---|---|---|---|---|---|---|---|
| E2 | Ppy (0.2M) | Flakes 0.66% | Nafion (0.25%) | 5 (0.9 V) | AQSA/HCl (0.1M) | 500 | 12.2 | 10 |
| | | (6 mg/ml) | | | | (1.0 V) | | |
| E3 | Ppy (0.2M) | Flakes 5.4% | Nafion (0.25%) | 5 (0.9 V) | AQSA/HCl 2^{nd} (0.1M) | 500 | 5.9 | 3 |
| | | (6 mg/ml) | | | | (1.0 V) | | |
| E4 | Ppy (0.2M) | Flakes 2.7% | Nafion (0.25%) | 5 (0.9 V) | pTSA (0.1M) | 500 | 16.4 | 6 |
| | | (6 mg/ml) | | | | (1.0 V) | | |
| E5 | Ppy (0.2M) | Flakes 1.8% | Nafion (0.25%) | 5 (0.9 V) | pTSA/HCl (0.1M) | 500 | 12.2 | 6 |
| | | (6 mg/ml) | | | | (1.0 V) | | |
| E6 | Ppy (0.2M) | Flakes 3.1% | Nafion (0.25%) | 5 (0.9 V) | NapSA (0.1M) | 500 | 21.1 | 6 |
| | | (6 mg/ml) | | | | (1.0 V) | | |
| E7 | Ppy (0.2M) | Flakes 4.8% | Nafion (0.25%) | 5 (0.9 V) | NapSA/HCl (0.1M) | 500 | 17 | 3 |
| | | (6 mg/ml) | | | | (1.0 V) | | |
| E8 | Ppy (0.2M) | Flakes 4.4% | Nafion (0.25%) | 5 (0.9 V) | NapDSA (0.1M) | 500 | 16 | 12 |
| | | (6 mg/ml) | | | | (1.0 V) | | |
| E9 | Ppy (0.2M) | Flakes 1% | PSSA (0.25%) | 5 (0.9 V) | Li₂SO₄ (0.1M) | 500 | 16.8 | 50 |
| | | (6 mg/ml) | | | | (0.8 V) | | |
| E10 | Ppy (0.2M) | Flakes 1.2% | PSS.Na (0.25%) | 5 (0.9 V) | Li₂SO₄ (0.1M) | 500 | 13 | 25 |
| | | (6 mg/ml) | | | | (0.8 V) | | |
| E11 | Ppy (0.2M) | Flakes 10% | PAA (0.25%) | 5 (0.9 V) | Li₂SO₄ (0.1M) | 500 | 12.2 | 17 |
| | | (6 mg/ml) | | | | (0.8 V) | | |
| E12 | Ppy (0.2M) | Flakes 7% | PAA.Na (0.25%) | 5 (0.9 V) | Li₂SO₄ (0.1M) | 500 | 11.6 | 75 |
| | | (6 mg/ml) | | | | (0.8 V) | | |
| E13 | Ppy (0.2M) | Flakes 9.3% | PMAA (0.25%) | 5 (0.9 V) | Li₂SO₄ (0.1M) | 500 | 5.5 | 670 |
| | | (6 mg/ml) | | | | (0.8 V) | | |

Effect of deposition charge (C) on the second layer

| | | | | | | | | |
|---|---|---|---|---|---|---|---|---|
| E14 | Ppy (0.2M) | Flakes 5.3% | Nafion (0.25%) | 5 (0.9 V) | Li₂SO₄ (0.1M) | 500 | 14 | 10 |
| | | (6 mg/ml) | | | | (0.8 V) | | |
| E15 | Ppy (0.2M) | Flakes 16.3% | Nafion (0.25%) | 5 (0.9 V) | Li₂SO₄ (0.1M) | 200 | 5.9 | 6 |
| | | (6 mg/ml) | | | | (0.8 V) | | |
| E16 | Ppy (0.2M) | Flakes 21% | Nafion (0.25%) | 5 (0.9 V) | Li₂SO₄ (0.1M) | 100 | 4.3 | 3 |
| | | (6 mg/ml) | | | | (0.8 V) | | |
| E17 | Ppy (0.2M) | Flakes 40% | Nafion (0.25%) | 5 (0.9 V) | Li₂SO₄ (0.1M) | 50 | 2.8 | 5 |
| | | (6 mg/ml) | | | | (0.8 V) | | |

TABLE 4
Charge capacities (CC) and discharge capacities (DC) at various cycle using different cathodes described in
Table 3 and electrolytes. All data is from 2032 coin cells using 13 mm diameter cathode, 17 mm diameter
separator (Solupor 730P, Lydall, UK) and 13 mm Li metal anode. All cells use 40 μL of electrolyte.

| | | | CC (mAh/g S) | DC (mAh/g S) | CC (mAh/g S) | DC (mAh/g S) |
|---|---|---|---|---|---|---|
| Cell # | Electrode | Electrolyte | 1^{st}, 10^{th} | 1^{st}, 10^{th} | 2nd, 10^{th} | 2nd, 10^{th} |
| E1 | PPy/S/CB/Naf/ | 50% P13FSI, LiFSI, NO₃, TFSI | 752, 861 (C/10) | 975, 869 (C/10) | 959, 861 (C/10) | 962, 869 (C/10) |
| | Li₂SO₄ | 50% DOL/TEGME (2:1) | | | | |
| E2 | PPy/S/Naf/CB/ | C₃mpyr FSI:TEGDME (1:1 vol); | 541, 686 C/100) | 662, 750 (C/100) | 541, 686 C/100) | 662, 750 (C/100) |
| | AQSA | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E3 | PPy/S/Naf/ | C₃mpyr FSI:TEGDME (1:1 vol); | 154, 174 C/100) | 174, 192 (C/100) | 154, 174 (C/100) | 174, 192 (C/100) |
| | CB/AQSA-H | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E4 | PPy/S/Naf/ | C₃mpyr FSI:TEGDME (1:1 vol); | 20, 0.3\hat{ } (C/100) | 0, 0\hat{ } (C/100) | 20, 0.3\hat{ } (C/100) | 0, 0\hat{ } (C/100) |
| | CB/pTSA | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E5 | PPy/S/Naf/ | C₃mpyr FSI:TEGDME (1:1 vol); | 1213, 968 (C/100) | 1400, 1063 (C/100) | 1213, 968 (C/100) | 1400, 1063 (C/100) |
| | CB/pTSA-H | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E6 | PPy/S/Naf/ | C₃mpyr FSI:TEGDME (1:1 vol); | 39, 29 (C/100) | 45, 30 (C/100) | 39, 29 (C/100) | 45, 30 (C/100) |
| | CB/NapSA | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E7 | PPy/S/Naf/ | C₃mpyr FSI:TEGDME (1:1 vol); | 158, 224 (C/100) | 223, 240 (C/100) | 158, 224 (C/100) | 223, 240 (C/100) |
| | CB/NapSA-H | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E8 | PPy/S/Naf/ | C₃mpyr FSI:TEGDME (1:1 vol); | 552, 398 (C/100) | 682, 471 (C/100) | 552, 398 (C/100) | 682, 471 (C/100) |
| | CB/NapDSA | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E9 | PPy/S/PSSA/ | C₃mpyr FSI:TEGDME (1:1 vol); | 293, 283 (C/10) | 291, 282 (C/10) | 293, 283 (C/10) | 291, 282 (C/10) |
| | CB/Li₂SO₄ | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E10 | PPy/S/PSS.Na/ | C₃mpyr FSI:TEGDME (1:1 vol); | 1430, 1325 (C/10) | 1470, 1356 (C/10) | 1430, 1325 (C/10) | 1470, 1356 (C/10) |
| | CB/Li₂SO₄ | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| 11 | PPy/S/PAA/ | C₃mpyr FSI:TEGDME (1:1 vol); | 240, 240 (C/10) | 242, 239 (C/10) | 240, 240 (C/10) | 242, 239 (C/10) |
| | CB/Li₂SO₄ | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E12 | PPy/S/PAA.Na/ | C₃mpyr FSI:TEGDME (1:1 vol); | 369, 321 (C/10) | 374, 322 (C/10) | 369, 321 (C/10) | 374, 322 (C/10) |
| | CB/Li₂SO₄ | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E13 | PPy/S/PMMA/ | C₃mpyr FSI:TEGDME (1:1 vol); | 116, 118 (C/10) | 114, 112 (C/10) | 116, 118 (C/10) | 114, 112 (C/10) |
| | CB/Li₂SO₄ | 0.5 mol · kg⁻¹ LiFSI + | | | | |
| | | 0.25 mol · kg⁻¹ LiTFSI + | | | | |
| | | 0.25 mol · kg⁻¹ LiNO₃ | | | | |
| E14 | PPy/S/Naf/CB/ | C₃mpyr FSI:TEGDME (1:1 vol); | 1380, 1255 (C/10) | 1413, 1266 (C/10) | 1380, 1255 (C/10) | 1413, 1266 (C/10) |
| | Li₂SO₄ | 0.5 mol · kg⁻¹ LiFSI + | | | | |
| | 500C | 0.25 mol · kg⁻¹ LiTFSI + | | | | |
| | | 0.25 mol · kg⁻¹ LiNO₃ | | | | |
| E15 | PPy/S/Naf/CB/ | C₃mpyr FSI:TEGDME (1:1 vol); | 990, 877 (C/10) | 1177, 942 (C/10) | 990, 877 (C/10) | 1177, 942 (C/10) |
| | Li₂SO₄ | 0.5 mol · kg⁻¹ LiFSI + | | | | |
| | 200C | 0.25 mol · kg⁻¹ LiTFSI + | | | | |
| | | 0.25 mol · kg⁻¹ LiNO₃ | | | | |
| E16 | PPy/S/Naf/CB/ | C₃mpyr FSI:TEGDME (1:1 vol); | 1076, 740 (C/10) | 1067, 756 (C/10) | 1076, 740 (C/10) | 1067, 756 (C/10) |
| | Li₂SO₄ | 0.5 mol · kg⁻¹ LiFSI + | | | | |
| | 100C | 0.25 mol · kg⁻¹ LiTFSI + | | | | |
| | | 0.25 mol · kg⁻¹ LiNO₃ | | | | |
| E17 | PPy/S/Naf/CB/ | C₃mpyr FSI:TEGDME (1:1 vol); | 423, 415 (C/10) | 538, 425 (C/10) | 423, 415 (C/10) | 538, 425 (C/10) |
| | Li₂SO₄ | 0.5 mol · kg⁻¹ LiFSI + | | | | |
| | 50C | 0.25 mol · kg⁻¹ LiTFSI + | | | | |
| | | 0.25 mol · kg⁻¹ LiNO₃ | | | | |

\hat{ }Problem with the cell

### Clauses

In a first embodiment of a first aspect, the invention provides a lithium-sulphur electric current producing cell comprising:
Anode;
Electrolyte; and
Cathode comprising a polymer-sulphur composite comprising:
   5 to 75 wt % sulphur;
   10 to 70 wt % conductive polymer;
   0 to 50 wt % of one or more conductive agents, other than the conductive polymer; and
   1 to 20 wt % a first dopant comprising a negatively charged organic polymer, or
Cathode comprising a polymer-sulfur composite comprising:
   5 to 80 wt % sulfur;
   10 to 90 wt % conductive polymer; and
   0 to 50 wt % of one or more conductive agents, other than the conductive polymer; and
   0.5 to 20 wt % of a first dopant comprising a negatively charged organic polymer,
      wherein the conductive polymer is doped with the negatively charged organic polymer.

In a second embodiment of the lithium-sulphur electric current producing cell according to the first embodiment, the first dopant is selected from the group consisting of sulfonated polymers, surfactants, fatty acids, proteins and carboxylated carbon based structures.

In a third embodiment of the lithium-sulphur electric current producing cell according to the first or second embodiments, the apparent contact angle of the cathode surface with the electrolyte is less than 20 odegrees at time=10 seconds.

In a fourth embodiment of the cell according to any one of the preceding embodiments, the polymer-sulphur composite further comprises a second dopant.

In a fifth embodiment of the cell according to the fourth embodiment, the second dopant comprises bis(alkylsulfonyl)imides anions, perfluorinated bis(alkylsulfonyl)imides anions, sulfate anions and/or perchlorate anions

In a sixth embodiment of the cell according to the fifth embodiment, the second dopant comprises bis(trifluoromethylsulfonyl)imide (TFSI) anions and/or bis(fluorosulfonyl)imide (FSI) anions.

In a seventh embodiment of the cell according to the fourth embodiment, the second dopant comprises sulphate anions.

In an eighth embodiment of the cell according to any one of the fourth to seventh, the second dopant comprising a mono- or di-alkaline cation.

In a ninth embodiment of the cell according to the eighth embodiment, the cation is lithium.

In a tenth embodiment of the cell according to any one of the preceding embodiments, the first dopant comprises a fluorinated sulfonic acid polymer.

In an eleventh embodiment of the cell according any one of the preceding embodiments, the conductive polymer is selected from the group consisting of polythiophene, polypyrrole, polyphenylene, polyaniline, polyacetylene, polyaromatic amines, and derivatives thereof.

In a twelfth embodiment of the cell according to any one of the preceding embodiments, the cell further comprises an electrically cathode support.

In a thirteenth embodiment of the cell according to the twelfth embodiment, the electrically conductive cathode support comprises flexible stainless steel mesh or flexible carbon fibre cloth.

In a fourteenth embodiment of the cell according to any one of the preceding embodiments, the polymer-sulphur composite comprises two layers, a first layer proximal to a cathode support and a second layer distal to the cathode support.

In a fifteenth embodiment of the cell according to the fourteenth embodiment, the first layer is less than 10 microns thick and the second layer is less than 100 microns thick.

In a sixteenth embodiment of the cell according to the fourteenth or fifteenth embodiment the first layer does not comprises second dopant.

In a seventeenth embodiment of the cell according to anyone of the preceding embodiments, the electrolyte comprises an ionic liquid and an organic solvent comprising dioxolanes and/or glymes

In an eighteenth embodiment of the cell according to any one of the preceding embodiments, the electrolyte comprises 10 to 90 wt % ionic liquid relative to the total amount of ionic liquid and organic solvent.

In a second aspect, the invention provides a polymer-sulphur composite as defined according to any one of the first to eighteenth embodiments for use in a cathode of a lithium-sulphur electric current producing cell as defined in the first embodiment.

In a third aspect, the invention provides an electrolyte as defined in the seventeenth or eighteenth embodiment for use in a cathode of a lithium-sulphur electric current producing cell as defined in the first embodiment.

In a fourth aspect, the invention provides a process for preparing a polymer-sulphur composite cathode comprising the step of coating the polymer-sulphur composite as defined in any one of the third to sixteenth embodiments onto a cathode support.

In a second embodiment of the process according to the fourth aspect, the coating is applied by electropolymerisation.

1.-20. (canceled)

21. A lithium-sulfur electric current producing cell comprising:
an anode;
an electrolyte; and,
a cathode comprising a polymer-sulfur composite comprising:
5 to 80 wt % sulfur;
10 to 90 wt % conductive polymer;
0 to 50 wt % of one or more conductive agents, other than the conductive polymer; and,
0.5 to 20 wt % of a first dopant comprising a negatively charged organic polymer;
wherein the conductive polymer is doped with the first dopant.

22. The cell of claim 21, wherein the first dopant is selected from the group consisting of sulfonated polymers, surfactant polymers, fatty acids, proteins and carboxylated carbon based polymer structures.

23. The cell of claim 22, wherein the first dopant comprises a fluorinated sulfonic acid polymer, polystyrene sulfonate, polyacrylic acid, or poly methacrylic acid, in acid or salt form.

24. The cell of claim 21, wherein the apparent contact angle of the cathode surface with the electrolyte is less than 20° at a time of 10 seconds after wetting.

25. The cell of claim 21, wherein the cell exhibits a discharge capacity and/or a charge capacity of at least 100 mAh/g (based on amount of S in the cathode) on cycle 10 and/or
wherein the cell invention exhibits a % change in the absolute values of the charge capacity and/or discharge capacity over at least cycle 2 to cycle 10 of less than 40%.

26. The cell of claim 21, wherein the polymer-sulfur composite further comprises a second dopant, wherein the second dopant comprises a salt comprising mono-alkali or di-alkaline cations and anions selected the group consisting of sulfate anions, perchlorate anions, bis(alkylsulfonyl)imides anion, and perfluorinated bis(alkylsulfonyl)imides anions, or bulky dopant compounds selected from the group consisting of anthraquinone sulfonic acid (AQSA), para-toluene sulfonic acid (pTSA), naphthalene sulfonic acid (NapSA), naphthalene di-sulfonic acid (NapDSA), naphthalene tri-sulfonic acid (NapTSA), naphthoic acid, naphthalene acetate, salts of negatively charged metal complexes, and mixtures thereof.

27. The cell claim 26, wherein the first and second dopants are dispersed within the conductive polymer.

28. The cell claim 21, wherein the conductive polymer is selected from the group consisting of polythiophene, polypyrrole, polyphenylene, polyaniline, polyacetylene, polyaromatic amines, derivatives thereof, and combinations thereof.

29. The cell of claim 21, wherein the polymer-sulfur composite comprises two layers, a first layer proximal to a cathode support and a second layer distal to the cathode support.

30. The cell of claim 29, wherein one or other of the first and second layers comprise one or both of the first dopant and a second dopant comprising a salt comprising mono-alkali or a di-alkaline cations and anions selected the group consisting of sulfate anions, perchlorate anions, bis(alkylsulfonyl)imides anion, and perfluorinated bis(alkylsulfonyl)imides anions, or bulky dopant compounds selected from the group consisting of anthraquinone sulfonic acid (AQSA), para-toluene sulfonic acid (pTSA), naphthalene sulfonic acid (NapSA), naphthalene di-sulfonic acid (NapDSA), naphthalene tri-sulfonic acid (NapTSA), naphthoic acid, naphthalene acetate, salts of negatively charged metal complexes, and mixtures thereof.

31. The cell of claim 29, wherein the cathode support is an electrically conductive cathode support.

32. The cell of claim 21, wherein the electrolyte comprises an ionic liquid and an organic solvent selected from the group consisting of dioxolanes, glymes, derivatives thereof, and combinations thereof.

33. The cell of claim 32, comprising 10 to 90 wt % of the ionic liquid relative to the total amount of ionic liquid and organic solvent.

34. A method of improving performance of a lithium-sulfur electric current producing cell comprising a step of doping one or more of a first layer and a second layer of a cathode composite material used in the cell with at least one of a first dopant and a second dopant comprising a salt comprising mono-alkali or a di-alkaline cations and anions selected the group consisting of sulfate anions, perchlorate anions, bis(alkylsulfonyl)imides anion and perfluorinated bis(alkylsulfonyl)imides anions, or bulky dopant compounds selected from the group consisting of anthraquinone sulfonic acid (AQSA), para-toluene sulfonic acid (pTSA), naphthalene sulfonic acid (NapSA), naphthalene di-sulfonic acid (NapDSA), naphthalene tri-sulfonic acid (NapTSA), naphthoic acid, naphthalene acetate, salts of negatively charged metal complexes, and mixtures thereof.

35. A polymer-sulfur composite comprising:
5 to 80 wt % sulfur;
10 to 90 wt % conductive polymer;
0 to 50 wt % of one or more conductive agents, other than the conductive polymer; and,
0.5 to 20 wt % of a first dopant comprising a negatively charged organic polymer,
wherein the conductive polymer is doped with the negatively charged organic polymer.
